(19) United States
(12) Patent Application Publication
(10) Pub. No.: US 2026/0358192 A1
(43) Pub. Date: Nov. 12, 2026

(54) OPTICAL TIME-DOMAIN REFLECTOMETRY EVENT DETECTION WITH LOSS AND REFLECTANCE MEASUREMENTS

(71) Applicant: EXFO Inc., Quebec (CA)

(72) Inventors: Jonathan Plante, Montreal (CA); Renaud Lesperance, Montreal (CA)

(21) Appl. No.: 19/670,760

(22) Filed: May 7, 2026

Related U.S. Application Data
(60) Provisional application No. 63/804,569, filed on May 12, 2025.

(51) Int. Cl. G01M 11/00; G06N 3/048

(52) U.S. Cl. CPC G01M 11/3145; G06N 3/048

(57) ABSTRACT

Example embodiments relate to optical time-domain reflectometry (OTDR) event detection with loss and reflectance measurements. One example embodiment includes a method. The method includes receiving, by a computing device, a plurality of optical time-domain reflectometry (OTDR) acquisitions that characterize an optical fiber. Each of the plurality of OTDR acquisitions represents backscatter and reflections from a respective test signal propagated through the optical fiber during a respective time window. The method also includes determining, by the computing device, one or more OTDR traces. Determining the one or more OTDR traces includes synthesizing one or more subsets of the OTDR acquisitions. Additionally, the method includes determining, by the computing device using an ensemble of machine-learned models and based on the one or more OTDR traces, locations and loss values associated with splices along the optical fiber.

### CROSS-REFERENCE TO RELATED APPLICATIONS

The present application is a non-provisional patent application claiming priority to Provisional Patent Application No. 63/804,569, filed May 12, 2025, the contents of which are hereby incorporated by reference.

### BACKGROUND

Optical fibers are optical components that transmit light from one end to another using total internal reflection. They can be made of glass or plastic and are widely used in telecommunications, lasers, and sensors.

The manufacturing process of optical fibers can produce small fluctuations in the optical fiber structure along any segment of the optical fiber. One way of identifying such fluctuations is performing optical time-domain reflectometry (OTDR) measurements. When such fluctuations in the optical fiber interact with the OTDR test pulses, a backscattering pattern that is usable to analyze the optical fiber is produced.

### SUMMARY

The specification and drawings disclose embodiments that relate to OTDR event detection with loss and reflectance measurements.

In a first aspect, the disclosure describes a method. The method includes receiving, by a computing device, a plurality of optical time-domain reflectometry (OTDR) acquisitions that characterize an optical fiber. Each of the plurality of OTDR acquisitions represents backscatter and reflections from a respective test signal propagated through the optical fiber during a respective time window. The method also includes determining, by the computing device, one or more OTDR traces. Determining the one or more OTDR traces includes synthesizing one or more subsets of the OTDR acquisitions. Additionally, the method includes determining, by the computing device using an ensemble of machine-learned models and based on the one or more OTDR traces, locations and loss values associated with splices along the optical fiber.

In a second aspect, the disclosure describes a non-transitory computer-readable medium, having stored thereon program instructions that, upon execution by a computing device, cause the computing device to perform operations. The operations include receiving a plurality of optical time-domain reflectometry (OTDR) acquisitions that characterize an optical fiber. Each of the plurality of OTDR acquisitions represents backscatter and reflections from a respective test signal propagated through the optical fiber during a respective time window. The operations also include determining one or more OTDR traces. Determining the one or more OTDR traces includes synthesizing one or more subsets of the OTDR acquisitions. Even further, the operations include determining, using an ensemble of machine-learned models and based on the one or more OTDR traces, locations and loss values associated with splices along the optical fiber.

In a third aspect, the disclosure describes a system. The system includes an optical time-domain reflectometry OTDR acquisition device configured to perform OTDR measurements on an optical fiber to obtain a plurality of OTDR acquisitions that characterize the optical fiber. Each of the plurality of OTDR acquisitions represents backscatter and reflections from a respective test signal propagated through the optical fiber during a respective time window. The system further includes a computing device. The computing device is configured to receive the plurality of OTDR acquisitions from the OTDR acquisition device. The computing device is also configured to determine one or more OTDR traces. Determining the one or more OTDR traces includes synthesizing one or more subsets of the OTDR acquisitions. Further, the computing device is configured to determine, using an ensemble of machine-learned models and based on the one or more OTDR traces, locations and loss values associated with splices along the optical fiber.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 is a block diagram illustration of a computing device, according to example embodiments.

FIG. 2 is a block diagram illustration of a cloud-based server cluster, according to example embodiments.

FIG. 3A is a diagram illustrating a system capable of performing an OTDR measurement, according to example embodiments.

FIG. 3B is a block diagram illustrating an OTDR device, according to example embodiments.

FIG. 3C is a block diagram illustrating an OTDR acquisition device of the OTDR device of FIG. 3B, according to example embodiments.

FIG. 4A is an illustration of a method for training a machine-learned model, according to example embodiments.

FIG. 4B is an illustration of a method for making a prediction using a machine-learned model, according to example embodiments.

FIG. 5A is a block diagram of a technique for detecting splices based on a plurality of OTDR acquisitions using an ensemble of machine-learned models, according to example embodiments.

FIG. 5B is a diagram that illustrates synthesizing one or more subsets of OTDR acquisitions, according to example embodiments.

FIG. 5C is a block diagram of a technique for detecting reflective events and splices based on a plurality of OTDR acquisitions using an ensemble of machine-learned models, according to example embodiments.

FIG. 6A is a block diagram illustrating a machine-learned model, according to example embodiments.

FIG. 6B is a block diagram illustrating a machine-learned model, according to example embodiments.

FIG. 6C is a block diagram illustrating a machine-learned model, according to example embodiments.

FIG. 6D is a block diagram illustrating a machine-learned model, according to example embodiments.

FIG. 6E is a block diagram illustrating a machine-learned model, according to example embodiments.

FIG. 6F is a block diagram illustrating a machine-learned model, according to example embodiments.

FIG. 6G is a block diagram illustrating a machine-learned model, according to example embodiments.

FIG. 7A is a plot illustrating a filter that is usable in a preprocessing technique, according to example embodiments.

FIG. 7B is a plot illustrating a filter that is usable in a preprocessing technique, according to example embodiments.

FIG. 7C is a plot illustrating a filter that is usable in a preprocessing technique, according to example embodiments.

FIG. 7D is a plot illustrating a filter that is usable in a preprocessing technique, according to example embodiments.

FIG. 7E is a plot illustrating a filter that is usable in a preprocessing technique, according to example embodiments.

FIG. 8A is an illustration of a set of parameters used to simulate OTDR data for training an ensemble of machine-learned models, according to example embodiments.

FIG. 8B is an illustration of a set of parameters used to simulate OTDR data for training an ensemble of machine-learned models, according to example embodiments.

FIG. 8C is plot comparing experimental results using the data from the parameters of FIG. 8A and the parameters of FIG. 8B, according to example embodiments.

FIG. 8D is plot comparing experimental results using the data from the parameters of FIG. 8A and the parameters of FIG. 8B, according to example embodiments.

FIG. 8E is plot comparing experimental results using the data from the parameters of FIG. 8A and the parameters of FIG. 8B, according to example embodiments.

FIG. 8F is a table comparing experimental results using the data from the parameters of FIG. 8A and the parameters of FIG. 8B, according to example embodiments.

FIG. 9A is an illustration of a set parameters used to simulate OTDR data for training an ensemble of machine-learned models, according to example embodiments.

FIG. 9B is a plot of experimental results generated using the data from the parameters of FIG. 9A, according to example embodiments.

FIG. 9C is a plot of experimental results generated using the data from the parameters of FIG. 9A, according to example embodiments.

FIG. 9D is a plot of experimental results generated using the data from the parameters of FIG. 9A, according to example embodiments.

FIG. 9E is a plot of experimental results generated using the data from the parameters of FIG. 9A, according to example embodiments.

FIG. 9F is a plot of experimental results generated using the data from the parameters of FIG. 9A, according to example embodiments.

FIG. 9G is a plot of experimental results generated using the data from the parameters of FIG. 9A, according to example embodiments.

FIG. 9H is a plot of experimental results generated using the data from the parameters of FIG. 9A, according to example embodiments.

FIG. 9I is a plot of experimental results generated using the data from the parameters of FIG. 9A, according to example embodiments.

FIG. 9J is a plot of experimental results generated using the data from the parameters of FIG. 9A, according to example embodiments.

FIG. 9K is a plot of experimental results generated using the data from the parameters of FIG. 9A, according to example embodiments.

FIG. 9L is a plot of experimental results generated using the data from the parameters of FIG. 9A, according to example embodiments.

FIG. 9M is a plot of experimental results generated using the data from the parameters of FIG. 9A, according to example embodiments.

FIG. 9N is a plot of experimental results generated using the data from the parameters of FIG. 9A, according to example embodiments.

FIG. 9O is a plot of experimental results generated using the data from the parameters of FIG. 9A, according to example embodiments.

FIG. 10 is a flowchart diagram illustrating a method, according to example embodiments.

### DETAILED DESCRIPTION

Example methods and systems are described herein. Any example embodiment or feature described herein is not necessarily to be construed as preferred or advantageous over other embodiments or features. The example embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the figures should not be viewed as limiting. It should be understood that other embodiments might include more or less of each element shown in a given figure. In addition, some of the illustrated elements may be combined or omitted. Similarly, an example embodiment may include elements that are not illustrated in the figures.

### I.Overview

During an OTDR measurement, laser pulses may be sent through an optical fiber and backscattered and reflected photons may be measured in order to provide information on the condition of the optical fiber along the optical path. In some cases, OTDR measurements may aim to characterize an optical fiber by identifying events such as a junction between fiber sections (spliced or connected), macro bends, fiber breaks, etc. Because the speed of light (e.g., the speed of light within the optical fiber under test) is known, the location of events along the optical fiber can be spatially determined using OTDR measurements.

Example embodiments herein relate to techniques for OTDR event detection with loss and reflectance measurements. For example, example embodiments may relate to applying an ensemble of machine-learned models (e.g., artificial neural networks (ANNs)) to a plurality of OTDR acquisitions used to measure an optical fiber. Upon applying the ensemble of machine-learned models, locations of splices and connectors (or other reflective events) may be identified within the optical fiber. Additionally, loss values and/or reflectance values associated with the splices and connectors may also be determined using the ensemble of machine-learned models.

In order to characterize optical fibers using OTDR, multiple OTDR acquisitions may be measured (i.e., light signals may be propagated along an optical fiber and the reflected light may be collected multiple times). These OTDR acquisitions may then be averaged or otherwise combined into one or more OTDR trace(s). Thereafter, the OTDR trace(s) may be analyzed in order to characterize the optical fiber.

However, in order to analyze OTDR trace(s), traditional methods may include positioning a first cursor along an OTDR trace waveform just before a suspected event and/or positioning a second cursor along the OTDR trace waveform just after a suspected event. The positioning of these cursor(s) may be done manually (e.g., by an OTDR technician) and/or algorithmically (e.g., by searching the OTDR trace waveform for a threshold crossing). For example, a fiber splice may correspond to a location of increased local optical loss along an optical fiber. Likewise, a connector may correspond to a location of increased optical reflectance along an optical fiber. Since fiber splices and/or connectors may be of interest to OTDR technicians, threshold intensities or threshold changes in intensity that correspond to fiber splices and/or connectors may be set that can be used to position cursors along an OTDR trace waveform.

Upon positioning the cursor(s), one or more analyses may be performed using the cursor(s). For example, a cursor may be placed before an apparent fiber splice and another cursor may be placed after the apparent fiber splice. Then, by comparing the intensity of the OTDR trace at the two cursor locations, an amount of optical loss occurring as a result of the splice may be determined.

Such traditional techniques may suffer significant shortcomings, though. Importantly, such traditional cursor-placement / cursor-analysis techniques may be susceptible to noise. For example, a noisy optical signal may cause the location of one or more cursors to be set incorrectly. This may be the result of a false triggering of a threshold (e.g., an apparent satisfying of a threshold condition due to optical or electrical noise rather than due to an actual splice or connector). Further, when one or more cursors are incorrectly positioned, one or more false positives may result (e.g., a reflective event, such as a connector, is identified within an OTDR trace where a reflective event did not, in fact, occur) and/or one or more measurements resulting from the cursor(s) (e.g., reflectance measurements, loss measurements, etc.) may be incorrect. For example, comparing an intensity value of an OTDR trace waveform at a cursor positioned before a splice and an intensity value of an OTDR trace waveform at a cursor positioned after a splice may lead to an inaccurate determination of a loss value of the splice if one of the cursors was positioned too far ahead of or too far beyond the location of the splice (e.g., due to optical or electrical noise).

Techniques described herein address these shortcomings of traditional OTDR analysis techniques. In particular, example embodiments may include synthesizing a series of OTDR acquisitions measured from an optical fiber into one or more OTDR traces. These OTDR traces may then be fed into an ensemble of machine-learned models configured to extract a series of characteristics about the optical fiber based on the OTDR traces. For example, the OTDR traces may be fed into a series of ANNs trained to extract various features about the optical fiber. In some embodiments, the ANNs may be interconnected (e.g., one or more of the ANNs may provide an output to or receive an input from one or more other ANNs).

In example embodiments, the one or more OTDR traces may correspond to small packets or subsets of acquisitions. For example, a first subset of OTDR acquisition data may be combined into a first OTDR trace that corresponds to a first range of acquisition time, a second subset of OTDR acquisition data may be combined into a second OTDR trace that corresponds to a second range of acquisition time, and so forth. The one or more traces may then be fed to the ensemble of machine-learned models in order to extract the positions and losses associated with one or more splices. In example embodiments, the ensemble of machine-learned models may also detect and/or characterize reflective events (e.g., connectors), and/or the end of the fiber.

Various types of machine-learned models may be used to analyze the OTDR traces. For instance, in some embodiments, the ensemble of machine-learned models may include a first model configured to generate a segmentation mask between portions of the OTDR trace waveform that correspond to the optical fiber (e.g., correspond to locations between an entrance end and an exit end of the optical fiber) and portions of the OTDR trace waveform that are beyond the optical fiber. This segmentation mask may then be provided to a reflective event detection machine-learned model, as well as to other machine-learned models in the ensemble (e.g., a machine-learned model configured to calculate the reflectance of reflective events, a machine-learned model configured to calculate the loss of reflective events, a machine-learned model configured to identify the end of the optical fiber, a machine-learned model configured to detect splices, and a machine-learned model configured to calculate the loss of splices). Upon receiving the segmentation mask, the reflective event detection machine-learned model may calculate probabilities of a reflective event for all locations along the optical fiber (e.g., discretized to 10 nm, 100 nm, 1 µm, 10 µm, etc.) based on the segmentation mask and the input OTDR trace waveform(s). These probabilities of reflective events may then be: (i) compared to a threshold to identify locations of reflective events and (ii) provided to additional machine-learned models (e.g., the machine-learned model configured to calculate the reflectance of reflective events, the machine-learned model configured to calculate the loss of reflective events, the machine-learned model configured to identify the end of the optical fiber, and the machine-learned model configured to detect splices). These additional machine-learned models, using the fiber segmentation mask; the reflective event probability; and the input OTDR trace waveform(s), may subsequently calculate the reflectance associated with reflective events along the optical fiber, the loss associated with reflective events along the optical fiber, the position of an end of the optical fiber (e.g., a refined position compared with the crude position identified in the segmentation mask), a splice position, and probabilities of a splice for all locations along the optical fiber (e.g., discretized to 10 nm, 100 nm, 1 µm, 10 µm, etc.). Still further, in some embodiments, one or more of the machine-learned models may be configured to (e.g., trained to) subsequently calculate a loss value for splices based on the probabilities of a splice for all locations along the optical fiber; the fiber segmentation mask; and the input OTDR trace waveform(s).

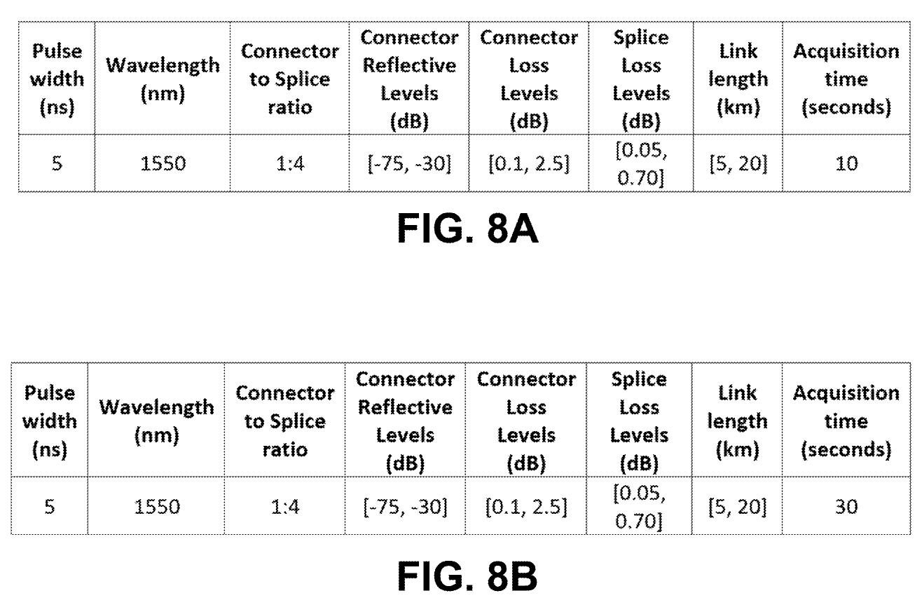

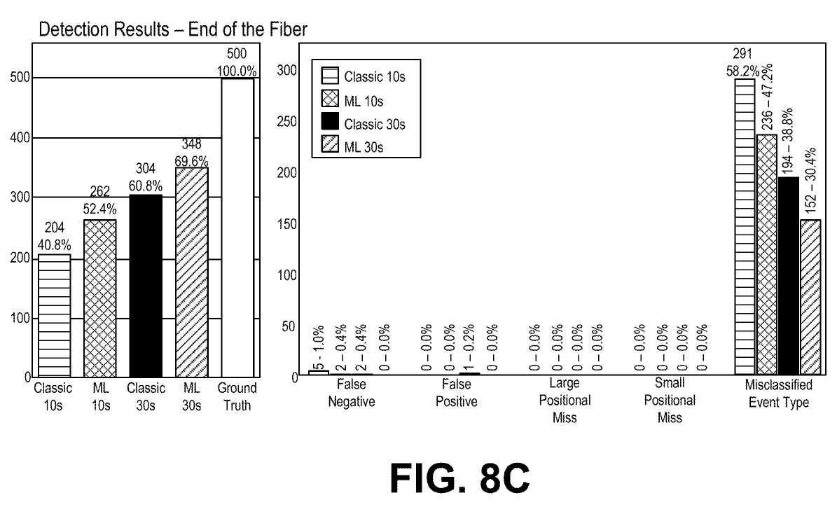

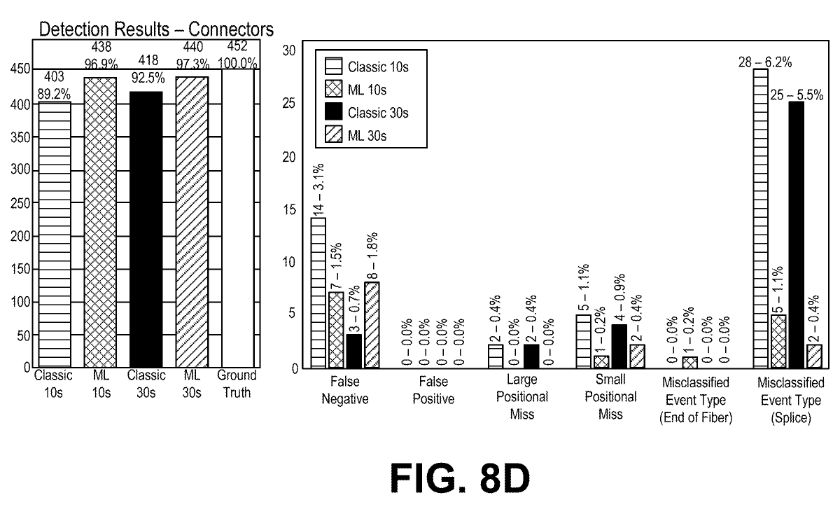

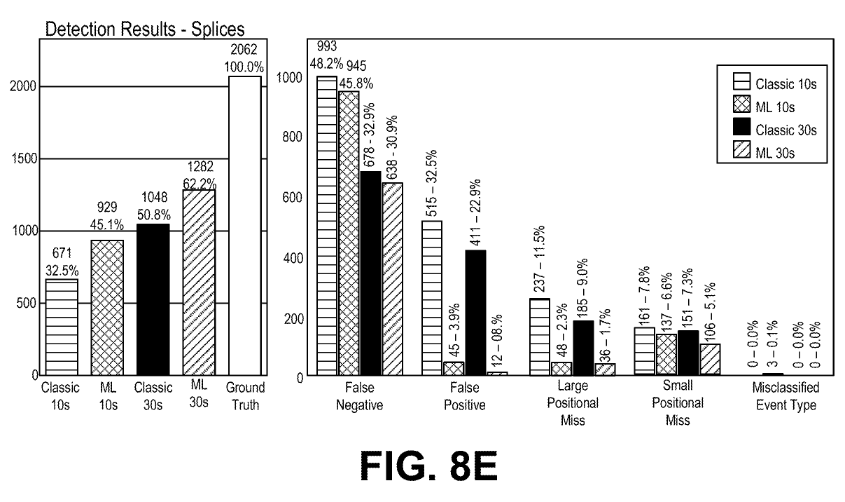

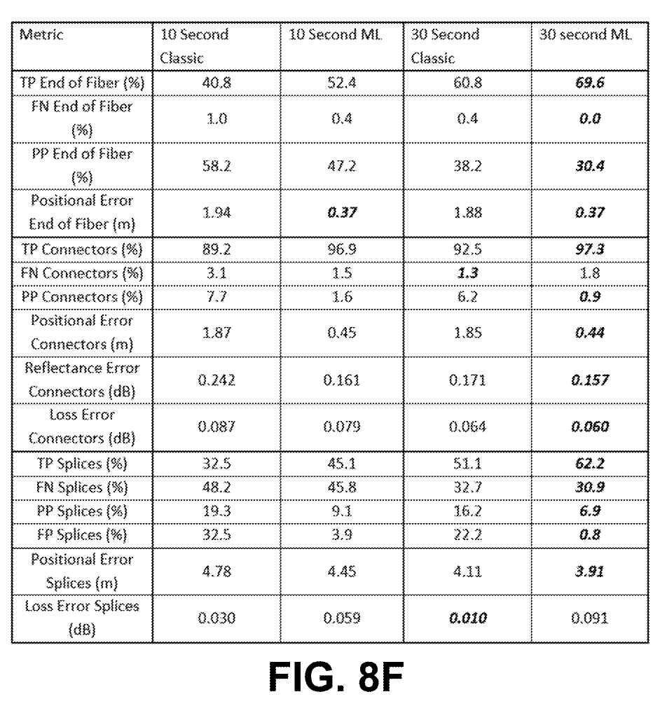

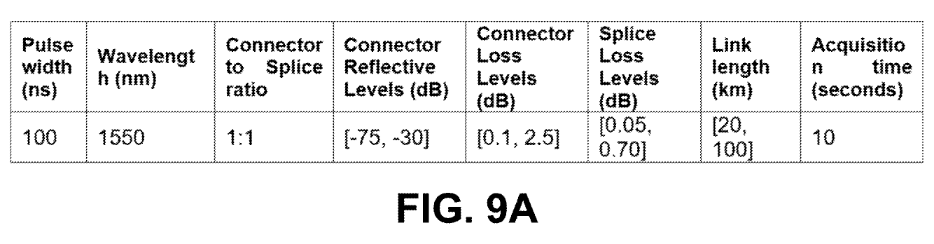

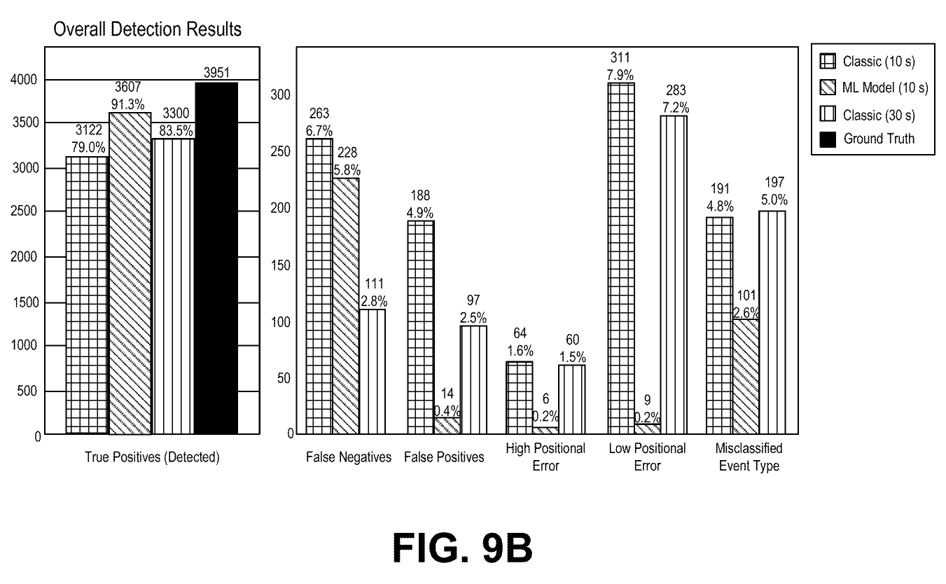

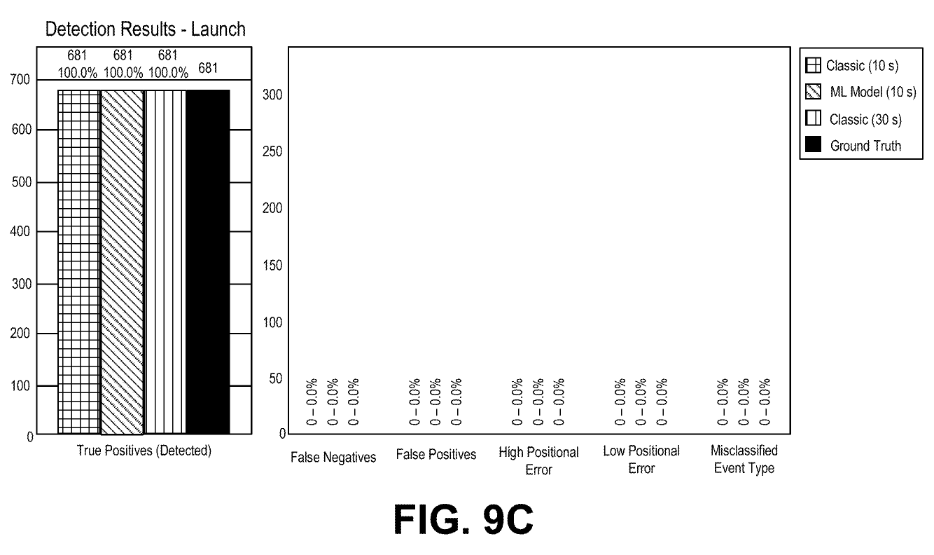

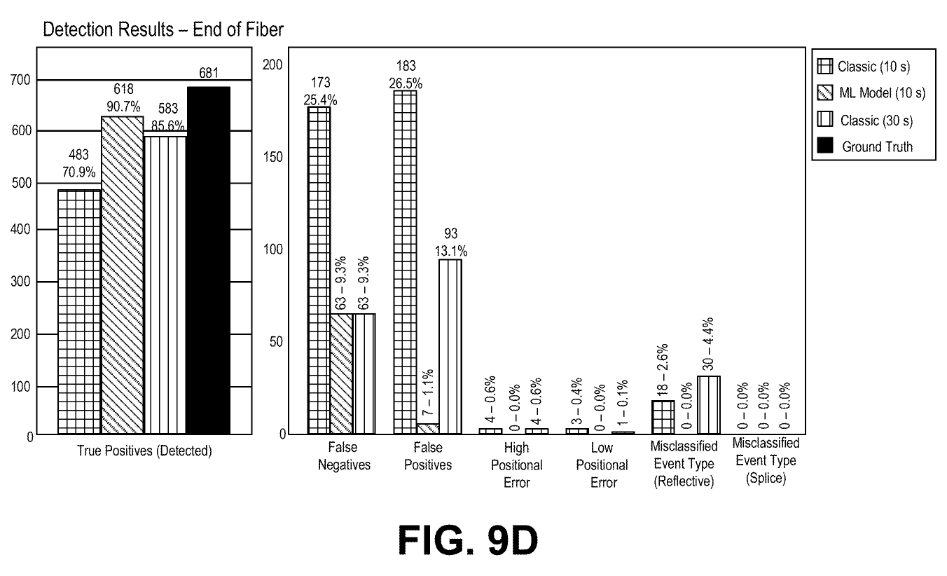

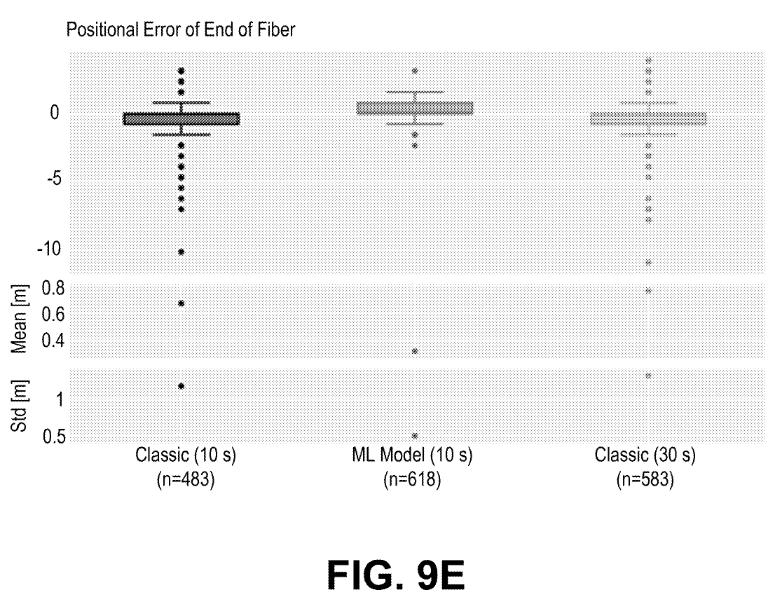

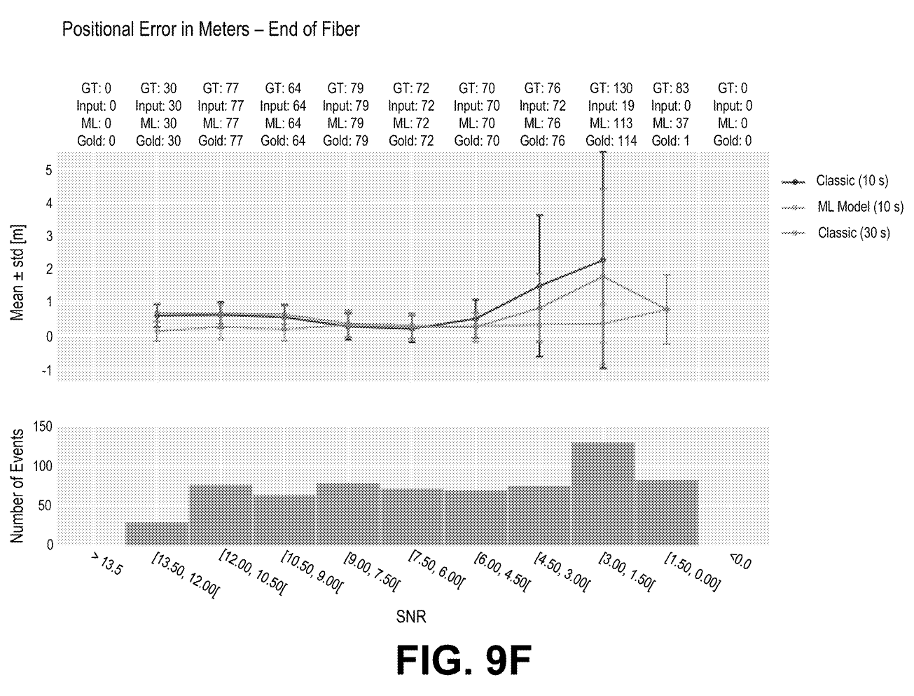

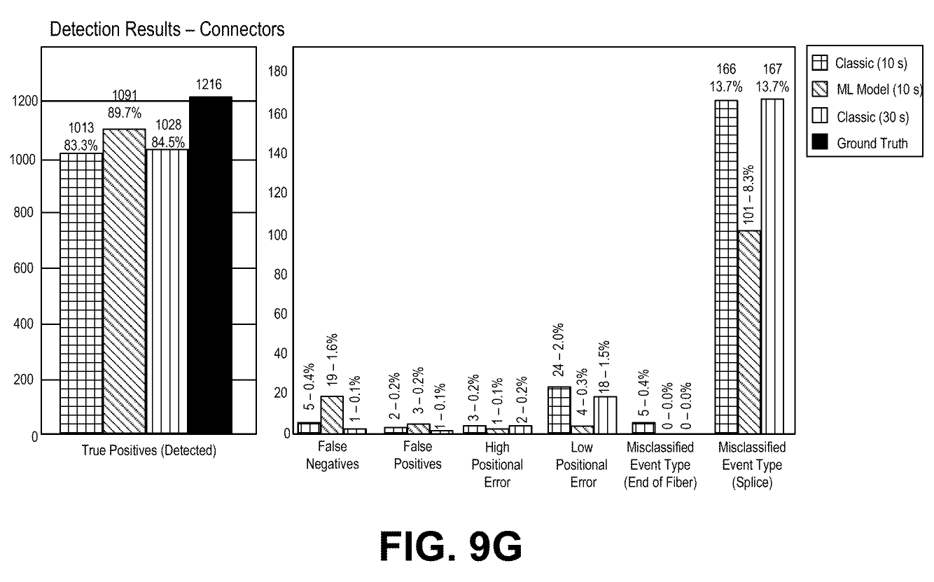

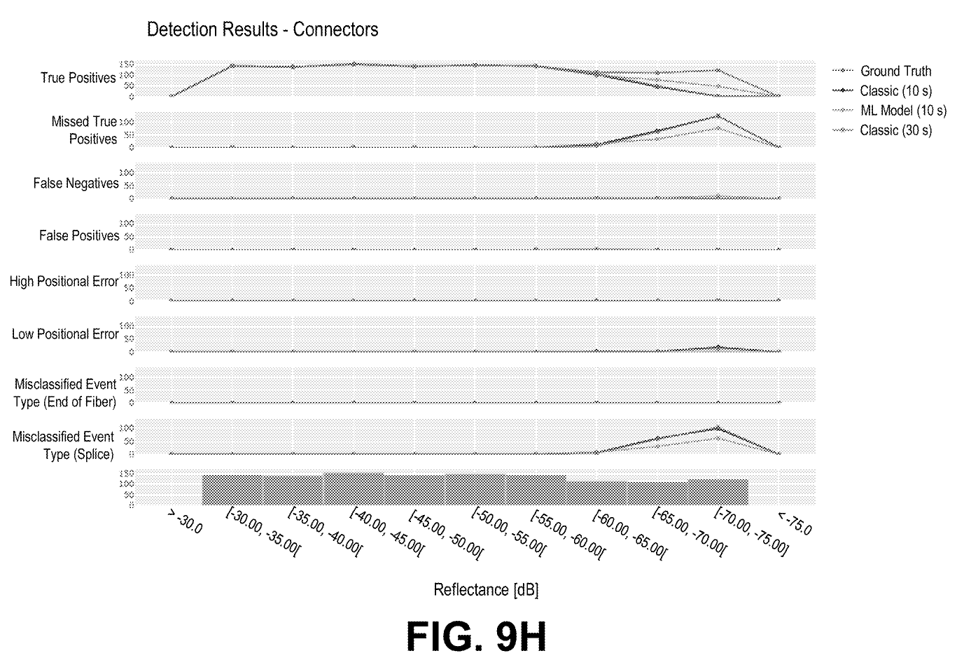

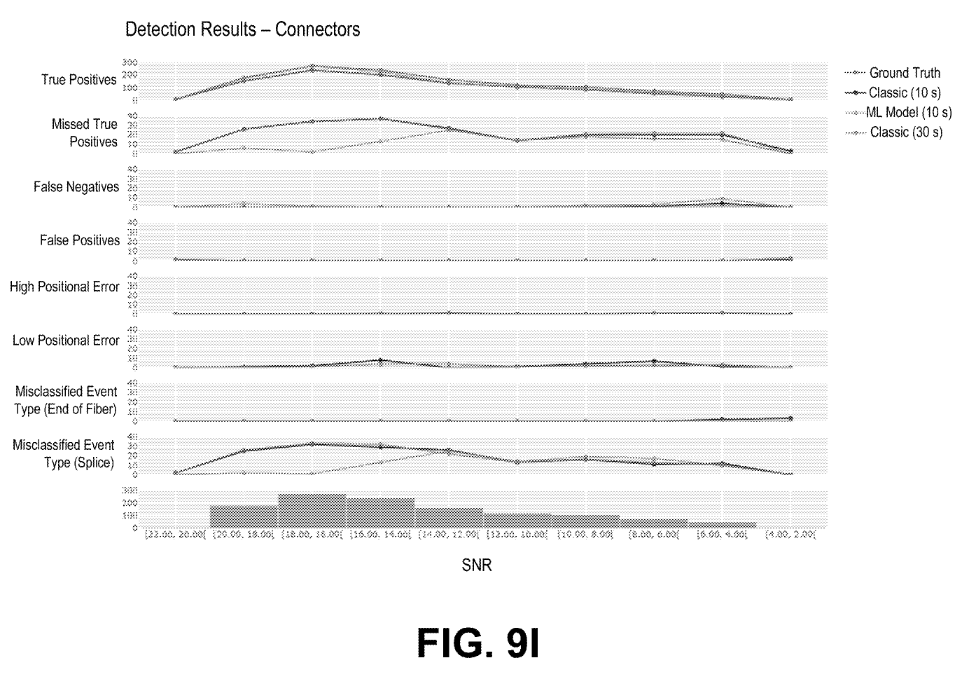

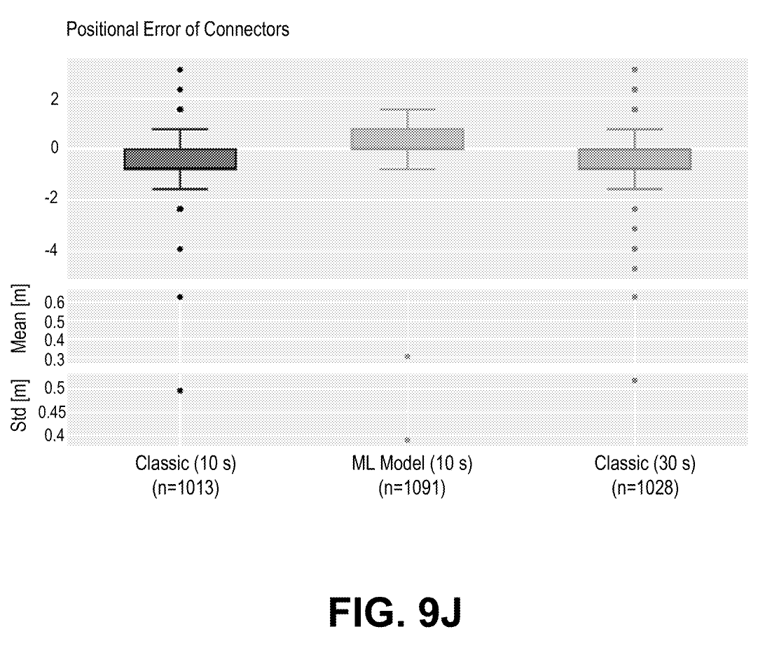

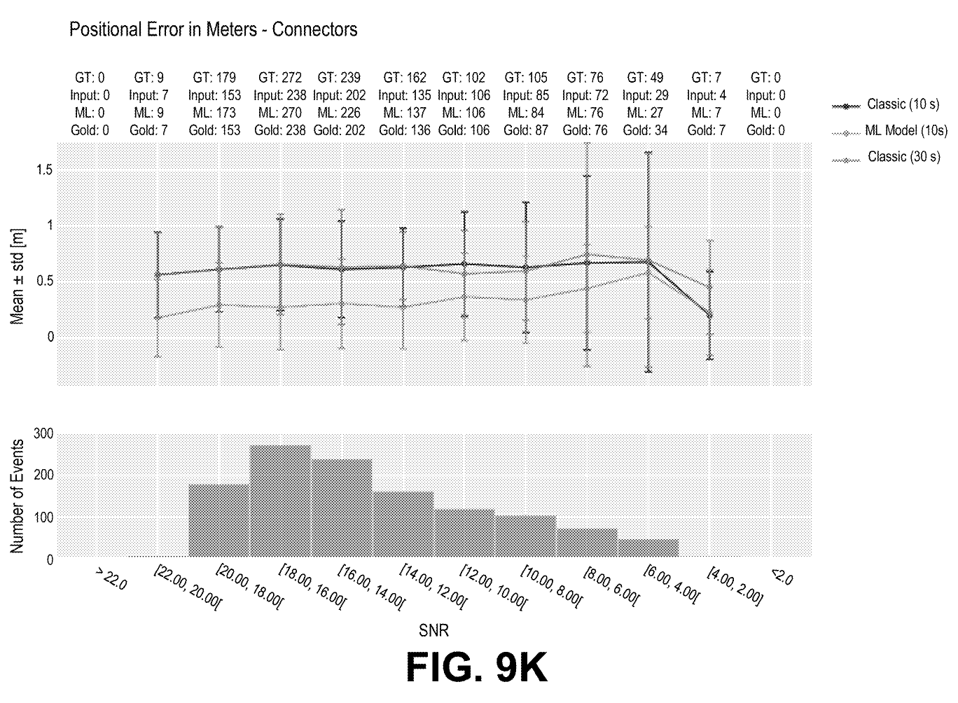

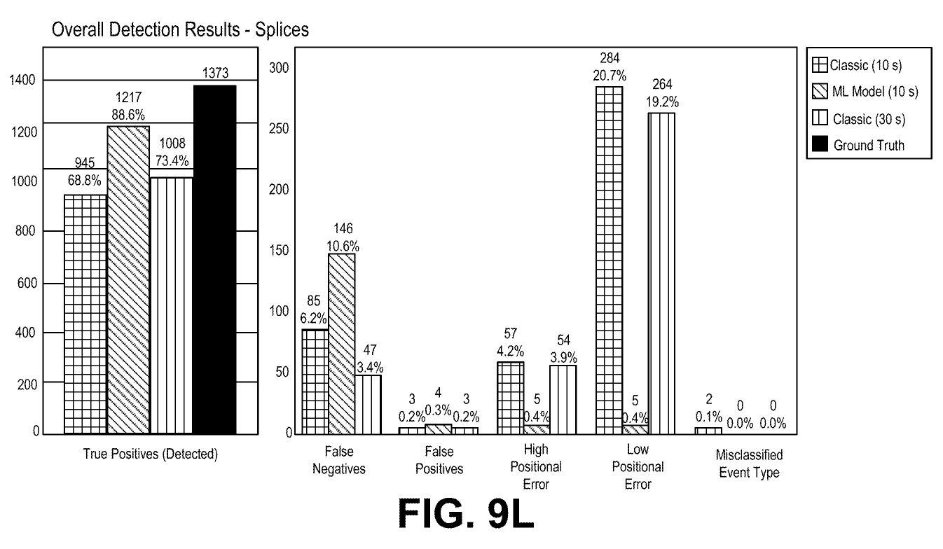

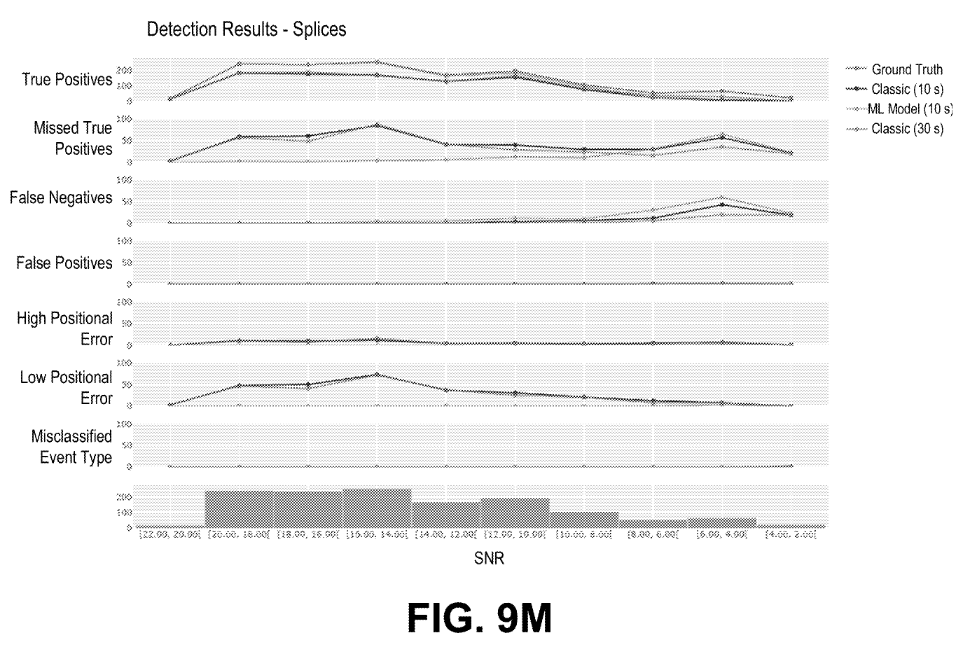

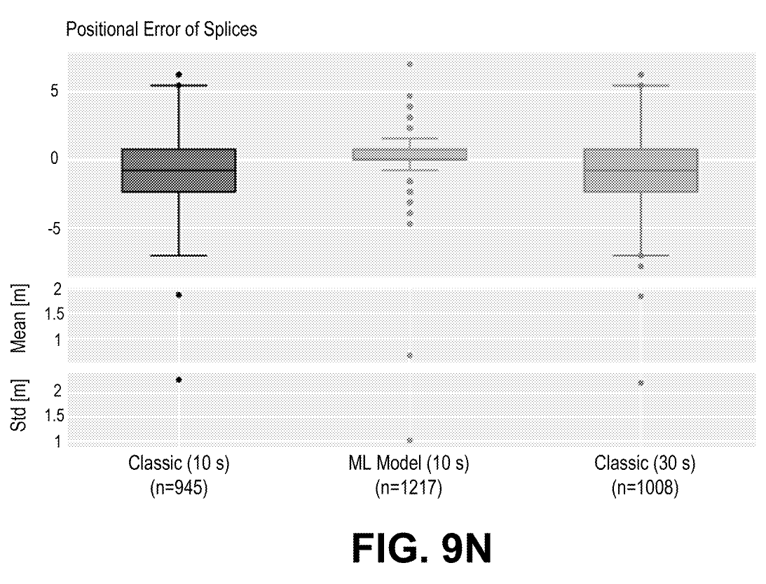

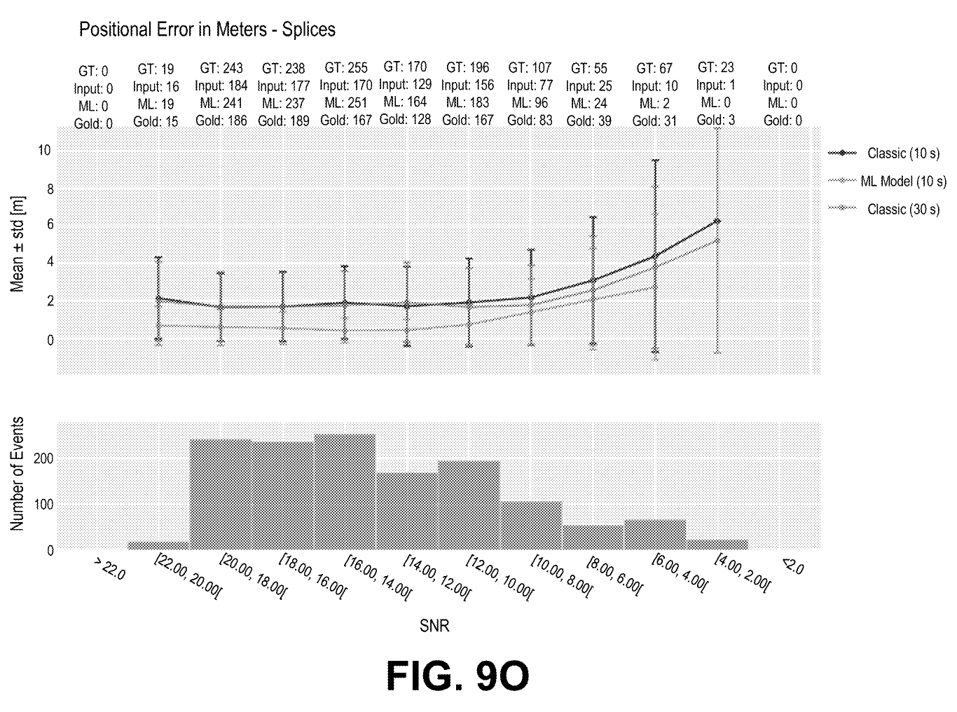

Because each of the models in the ensemble of machine-learned models is trained on precise training data (e.g., ground truth training data), the results generated for various characteristics of the machine-learned model may have reduced susceptibility to noise (shown and described below with reference to FIGS. 8A-9O) compared with traditional techniques. Further, and crucially, the time required to calculate the characteristics of optical fibers based on OTDR acquisitions (e.g., to identify cracks, breaks, connectors, splices, bends, etc. within optical fibers using OTDR) is also reduced. For example, techniques described herein can obtain comparable results to traditional techniques in a shorter amount of time. Additionally, techniques described herein can obtain superior results (e.g., results with more accuracy, reliability, and precision) to traditional techniques if allotted equivalent OTDR acquisition time.

Example embodiments described herein provide improvements over alternative techniques (e.g., in terms of noise resilience, OTDR acquisition time, accuracy, etc.) for a variety of reasons. In addition to the reasons described above, example embodiments may also synthesize OTDR traces using a relatively constrained set (e.g., small number) of OTDR acquisitions. For example, in traditional OTDR techniques, an OTDR trace waveform may represent an average of all OTDR acquisition waveforms measured over the course of 10 s. However, in example embodiments herein, rather than feeding a single OTDR trace waveform averaged over 10 s into an ensemble of machine-learned models, ten separate OTDR trace waveforms (each representing an averaging of OTDR acquisition waveforms over the course of 1 s apiece) may be provided to the ensemble of machine-learned models. By feeding in a plurality of more concise OTDR trace waveforms, techniques described herein may readily distinguish between noise, on the one hand, and small reflectance or small losses, on the other. Oppositely, when using a single OTDR trace (e.g., similar to traditional OTDR techniques), it may be challenging (e.g., for the ensemble of machine-learned models) to determine whether a peak (e.g., a peak that is similar in magnitude to the noise level) is a reflective event or not. By using a plurality of OTDR traces averaged over smaller timescales, the ensemble of machine-learned models can more readily make this distinction by analyzing whether a peak is present in all OTDR traces (thus likely a reflective event) or if, instead, the peak was only present in one or a small number of OTDR traces (thus likely due to random noise). Further, such a distinction can be made without requiring an increase in the overall acquisition time (e.g., ten instances of 1 s OTDR acquisitions may be used as opposed to a single instance of a 10 s OTDR acquisition).

In addition to synthesizing shorter OTDR acquisitions into a plurality of OTDR traces (as opposed to a single OTDR trace), example embodiments provide yet further improvements over alternative techniques. For example, a variety of different architectures are possible for the machine-learned models described herein. As described above, the machine-learned models may include ANNs. These ANNs may include a series of layers (e.g., convolutional layers). Further, in some embodiments, prior to feeding the captured OTDR acquisitions to the machine-learned model, one or more preprocessing techniques may be applied to the OTDR acquisitions and/or to the synthesized OTDR traces (e.g., the averaged OTDR acquisitions) in order to improve the results. The preprocessing techniques may include a plurality of different preprocessing techniques, each associated with various machine-learned models within the ensemble of machine-learned models. For example, in some embodiments, the preprocessing techniques may include filters that are convolved with the OTDR traces to extract and/or emphasize certain features of the OTDR traces. As just one example, prior to the OTDR traces being provided to a machine-learned model that is trained to identify splices within an OTDR trace, each of the OTDR traces may be convolved with a Laplacian filter in order to eliminate peaks in intensity from the respective OTDR trace (e.g., in order to emphasize reflective events). By filtering out events that necessarily do not correspond to splices (e.g., as determined based on one or more of the event’s underlying characteristics), the machine-learned models can focus on only those events that may properly correspond to splices, thereby speeding up the computation time and enhancing the results. Other filters are also possible and described herein. By applying these preprocessing filters, the embodiments described herein further enhance OTDR detection results beyond the traditional techniques.

### II. Example Systems

The following description and accompanying drawings will elucidate features of various example embodiments. The embodiments provided are by way of example, and are not intended to be limiting. As such, the dimensions of the drawings are not necessarily to scale.

The manufacturing processes used for optical fibers can produce small fluctuations in the optical fiber structure along one or more segments of the optical fiber. When such fluctuations interact with OTDR test pulses, they may create interferences and modulations that produce a backscattering pattern in the acquired OTDR trace.

OTDR may be used to characterize optical fibers. Further, OTDR may include a diagnostic technique where light pulses are launched into an optical fiber link and the returning light (e.g., arising from backscattering and reflections along the fiber link) is acquired and analyzed (e.g., by an OTDR acquisition device). Various “events” along the optical fiber may be detected and characterized through a proper analysis of the returning light in the time domain. As a result, the insertion loss of the optical fiber under test, as well as each component along the optical fiber, may be characterized and/or localized using OTDR.

The acquired power level of the return signal as a function of time may be referred to as the “OTDR trace” (i.e., the “reflectometric trace”). Further, the point in time along the OTDR trace may be representative of the distance between the OTDR acquisition device and a point along the optical fiber.

In the following description, general OTDR measurement techniques and OTDR trace processing techniques will not be explained in detail herein. For example, traditional signal processing methods for identifying and characterizing events from an OTDR trace will not be described in detail. Similarly, optical hardware and electronics present in an OTDR acquisition device for performing OTDR acquisitions on an optical fiber will not be described in an overly detailed fashion.

In the context of OTDR techniques, each light acquisition may involve propagating a large number of substantially identical light pulses in an optical fiber and combining the results. Each “OTDR acquisition” is understood to refer to the actions of propagating a test signal that includes one or more test light pulses having the same pulse width in the optical fiber and detecting corresponding return light signal from the optical fiber as a function of time. A test light-pulse signal travelling along the optical fiber will return towards its point of origin either through (distributed) backscattering or (localized) reflections. Multiple return light pulses representative of the acquired power level of backscatter and reflections of test light pulses may be averaged over time. Such an averaged set of return light pulses may be referred to as an “OTDR trace.” In an OTDR trace, the return time may be representative of the distance between the OTDR acquisition device and a point along the optical fiber. Light acquisitions may be repeated with varied acquisition parameters to produce a separate OTDR trace for each set of acquisition parameters (e.g., pulse widths, sampling rates, gain values, bandwidths, wavelengths, etc.). As used herein, an “OTDR trace” may be a representation of an intensity of backscatter and reflections measured during one or more OTDR acquisitions. It is understood that such an intensity may be represented as a “waveform” and that the terms “OTDR trace” and “OTDR trace waveform” are used interchangeably throughout.

As used herein, “backscattering” refers to Rayleigh scattering occurring from the interaction of the travelling light with the optical fiber media all along the optical fiber, resulting in a generally sloped reflected signal (e.g., measured in logarithmic units such as dB) for the OTDR trace. “Events” along the optical fiber may result in a localized drop of the backscattered light on the OTDR trace (e.g., which is attributable to a localized loss) and/or in a localized reflection peak on the OTDR trace.

An “event” characterized by the OTDR techniques described herein may be generated by any perturbation along the optical fiber that affects the returning light. For example, an event may be generated by an optical fiber splice along the optical fiber, which may be characterized by a localized loss with little or no reflection. Additionally or alternatively, mating connectors may generate events that typically cause enhanced reflections (although such connectors may be difficult to detect in some instances). OTDR techniques may also be used to identify events such as an optical fiber breakage (e.g., characterized by substantial localized loss and, frequently, a concomitant reflection peak) and/or a bend in the optical fiber (e.g., characterized by a wavelength-dependent loss). Still further, any other component along the optical fiber may also give rise to an “event” that generates localized loss.

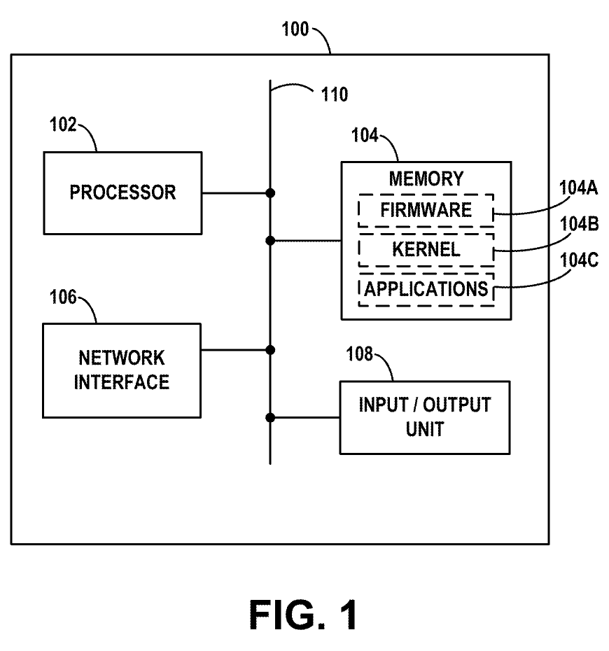

FIG. 1 is a block diagram of a computing device 100, according to example embodiments. FIG. 1 illustrates some of the components that may be included in a computing device arranged to operate in accordance with the embodiments herein. For example, the computing device 100 may represent portions of an OTDR device and/or an OTDR acquisition device. Computing device 100 may be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input / output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a CPU, a co-processor (e.g., a mathematics, graphics, or encryption co-processor, a neural processing unit (NPU), or a tensor processing unit (TPU)), a digital signal processor (DSP), a graphics processing unit (GPU), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. In some embodiments, for example, firmware 104A may include a basic input / output system (BIOS). Kernel 104B may be an operating system, including modules for memory management, scheduling and management of processes, input / output, and communication. Kernel 104B may also include device drivers that allow the operating system to communicate with the hardware modules (e.g., memory units, networking interfaces, ports, and buses) of computing device 100. Applications 104C may be one or more user-space software programs (e.g., mobile applications), such as web browsers, games, or email clients, as well as any software libraries used by these programs. For example, in some embodiments, applications 104C may include one or more machine-learned models used to carry out the OTDR analyses described herein. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (WIFI), BLUETOOTH, global positioning system (GPS), third-generation (3G), fourth-generation (4G), long-term evolution (LTE), fifth-generation (5G), or a wide-area wireless interface. However, other forms of physical layer interfaces and other types of standard or proprietary communication protocols may be used over network interface 106. Furthermore, network interface 106 may include multiple physical interfaces. For instance, some embodiments of computing device 100 may include Ethernet, BLUETOOTH, and WIFI interfaces.

Input / output unit 108 may facilitate user and peripheral device interaction with computing device 100. Input / output unit 108 may include one or more types of input devices, such as a keyboard, a mouse, a touch screen, and so on. Similarly, input / output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support the embodiments herein. The exact physical location, connectivity, and configuration of these computing devices may be unknown and/or unimportant to client devices. Accordingly, the computing devices may be referred to as “cloud-based” devices that may be housed at various remote data center locations.

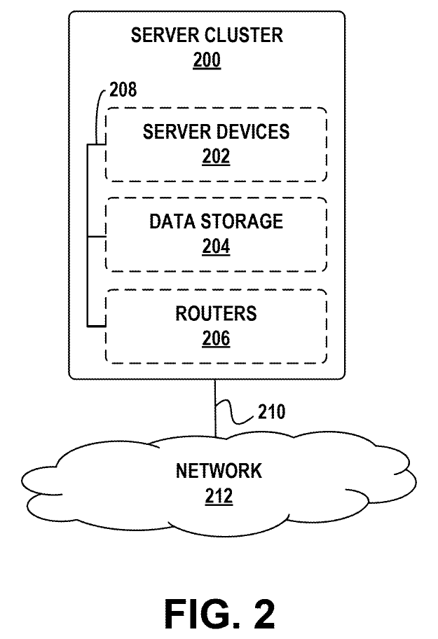

FIG. 2 depicts a server cluster 200 (e.g., a cloud-based server cluster) in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature is understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Routers 206 may include networking equipment configured to provide internal and external communications for server cluster 200. For example, routers 206 may include one or more packet-switching and/or routing devices (including switches and/or gateways) configured to provide: (i) network communications between server devices 202 and data storage 204 via local cluster network 208 and/or (ii) network communications between server cluster 200 and other devices via communication link 210 to network 212.

Additionally, the configuration of routers 206 can be based at least in part on the data communication requirements of server devices 202 and data storage 204; the latency and throughput of the local cluster network 208; the latency, throughput, and cost of communication link 210; and/or other factors that may contribute to the cost, speed, fault-tolerance, resiliency, efficiency, and/or other design goals of the system architecture.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations (e.g., accessible via a web browser). Such a representation may take the form of a markup language, such as HyperText Markup Language (HTML), eXtensible Markup Language (XML), or some other standardized or proprietary format. Moreover, server devices 202 may have the capability of executing various types of computerized scripting languages, such as, but not limited to, Perl, Python, PHP Hypertext Preprocessor (PHP), Active Server Pages (ASP), JAVASCRIPT, and so on. Computer program code written in these languages may facilitate the providing of web pages to client devices, as well as client device interaction with the web pages. Alternatively or additionally, JAVA may be used to facilitate generation of web pages and/or to provide web application functionality.

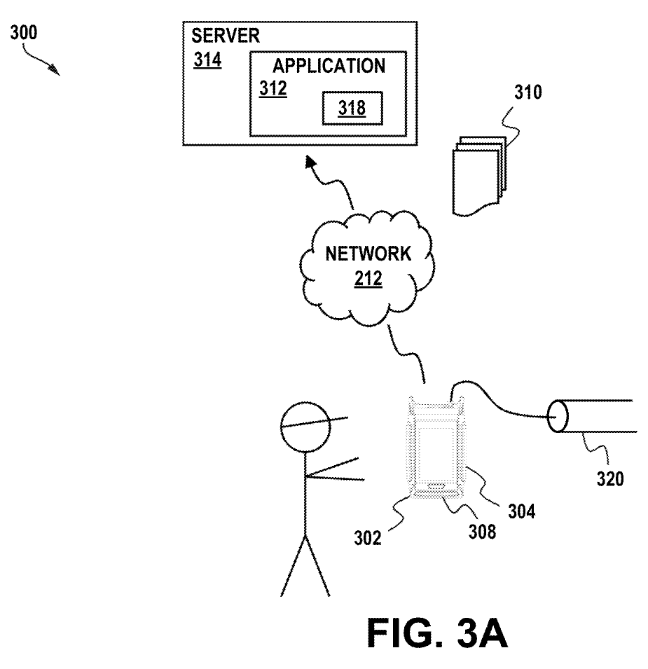

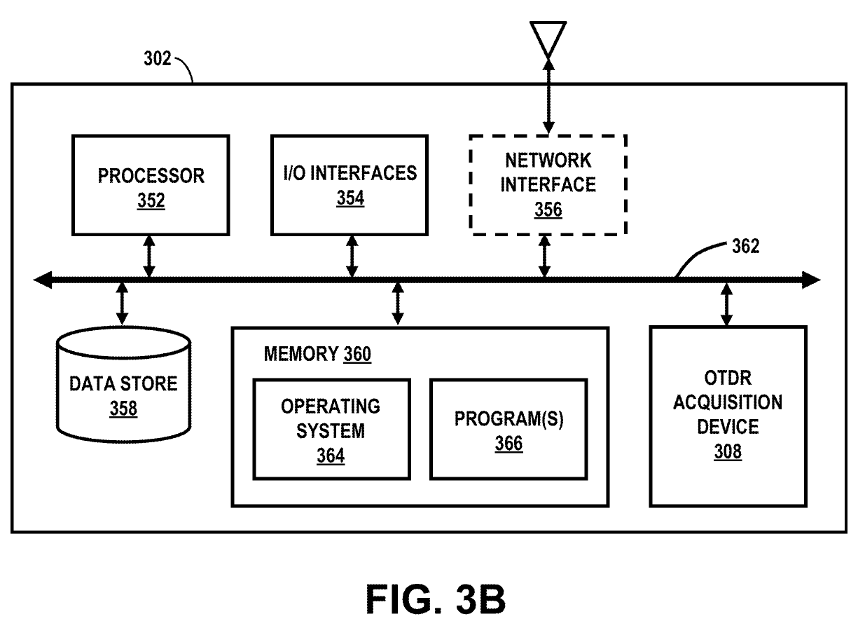

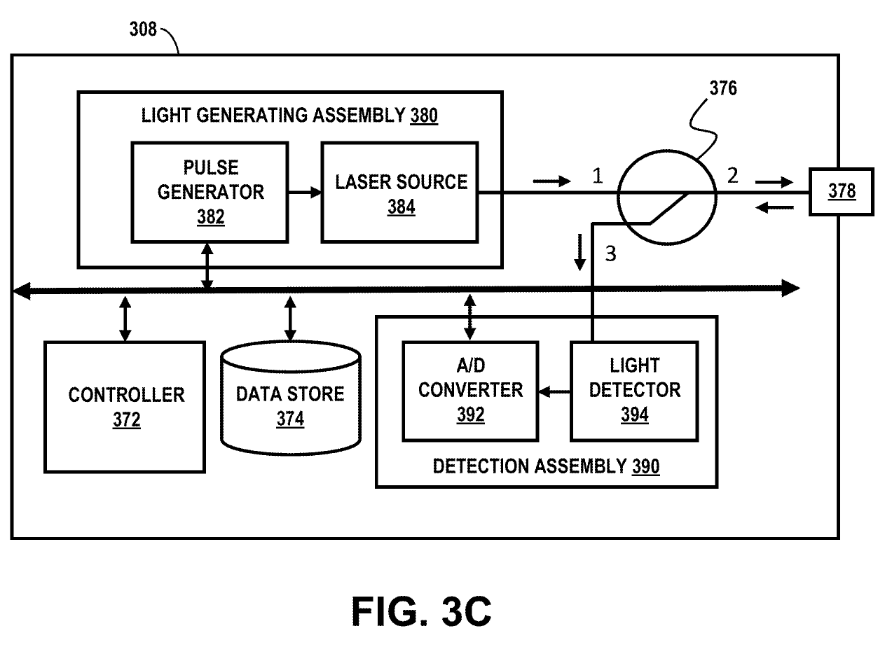

FIG. 3A illustrates a system 300 configured to generate, communicate, and store OTDR measurement results (e.g., initiated by a network operator or technician). As illustrated, the system 300 may include an OTDR device 302 that includes an OTDR acquisition device 308 configured to perform OTDR measurements on an optical fiber 320 (e.g., an optical fiber that is at least 1 km, at least 5 km, at least 10 km, at least 15 km, at least 20 km, at least 25 km, at least 50 km, or at least 100 km in length). When testing the optical fiber 320, the OTDR device 302 may generate one or more OTDR measurement data files 310 (e.g., each of which may include one or more OTDR traces that were acquired to characterize the optical fiber 320). In some embodiments, the OTDR measurement data files 310 may include parameters of the optical fiber 320 (e.g., as determined based on the acquired OTDR trace(s) by an OTDR analysis module 304 that is part of the OTDR device 302).

The OTDR measurement data files 310 may be transferred to a server-based test application 312 that receives the OTDR measurement data files 310 and may optionally track the progress and completion of the OTDR measurement and/or accept and/or verify OTDR measurement data files 310. The test application 312 may be located in a server 314 (e.g., similar to the server devices 202 in the server cluster 200 shown and described with reference to FIG. 2). The server 314 and the OTDR device 302 may communicate over a network (e.g., such as the network 212 shown and described with reference to FIG. 2). In some embodiments, a test report may be prepared by the technician (e.g., using the OTDR device 302) and transferred to the test application 312 (e.g., via the network 212) in addition to or instead of the OTDR measurement data files 310. In some embodiments, a test report may be prepared by the test application 312.

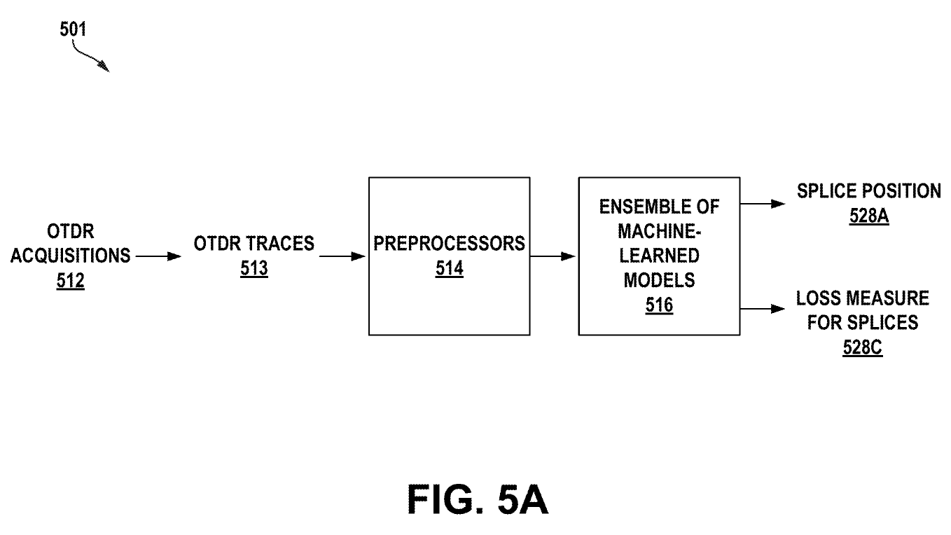

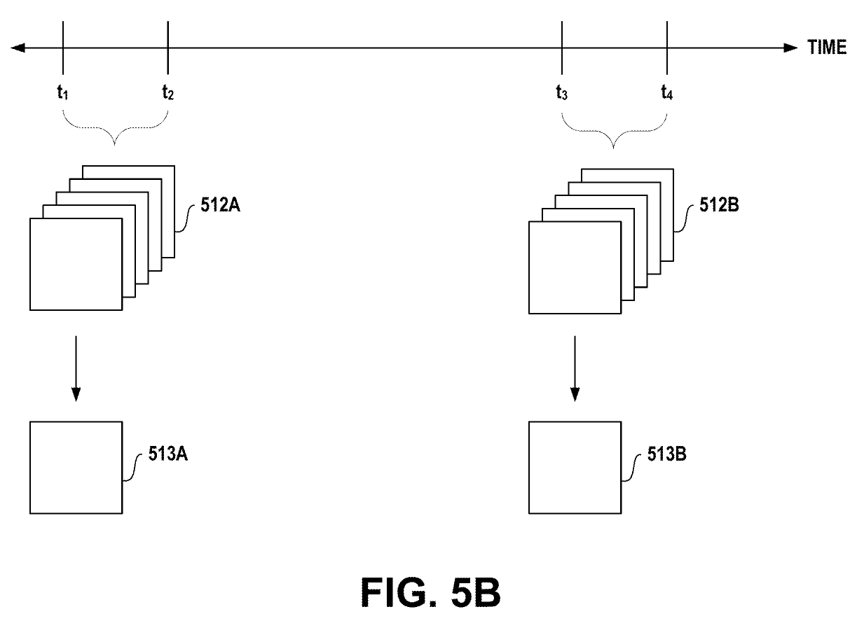

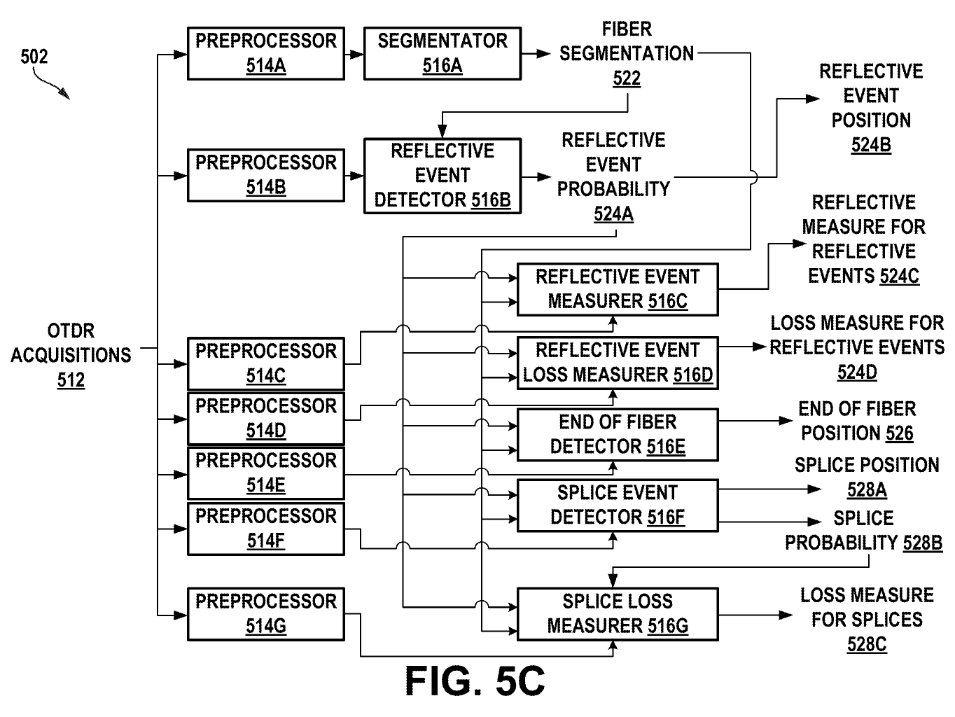

In the system 300 illustrated in FIG. 3A, the test application 312 and/or the OTDR device 302 may include an OTDR trace analysis module 318. The OTDR trace analysis module 318 may be configured to accept the OTDR measurement data files 310 and, based on the data files, identify various characteristics about the optical fiber 320 based on one or more OTDR traces synthesized from the OTDR measurement data files 310. For example, the OTDR trace analysis module 318 may include an ensemble of machine-learned models configured to determine locations, reflectance values, and loss values associated with discrete reflective events (e.g., connectors) along the optical fiber; a location of an end of the optical fiber; and/or locations and loss values associated with splices along the optical fiber. The ensemble of machine-learned models are shown and described in more detail below with reference to FIGS. 5-7E.

FIG. 3B is a block diagram of an OTDR device (e.g., the OTDR device 302 shown and described with reference to FIG. 3A). The OTDR device 302 may be a digital device that includes a processor 352 (e.g., similar to the processor 102 shown and described with reference to FIG. 1), input/output (I/O) interfaces 354 (e.g., similar to the input / output unit 108 shown and described with reference to FIG. 1), a network interface 356 (e.g., similar to the network interface 106 shown and described with reference to FIG. 1), a data store 358, a memory 360, and an OTDR acquisition device (e.g., similar to the OTDR acquisition device 308 shown and described with reference to FIG. 3A). In other embodiments, additional and/or alternative components may be included in the OTDR device 302.

A local interface 362 may interconnect one or more of the components of FIG. 3B. The local interface 362 may include, for example, one or more buses or other wired or wireless connections. In some embodiments, the local interface 362 may include controllers, buffers (caches), drivers, repeaters, and/or receivers to enable communication between components. Further, the local interface 362 may include address, control, and/or data connections that enable appropriate data routing among the components of the OTDR device 302.

When the OTDR device 302 is in operation, the processor 352 may be configured to execute instructions stored within the memory 360, to communicate data to and from the memory 360 and/or to control operations of the OTDR device 302. In some embodiments, the processor 352 may include a mobile processor optimized for power consumption and/or mobile applications. The I/O interfaces 354 may be used to receive user input from and/or for providing system output. User input can be provided via, for example, a keypad, a mouse, a touch screen, a scroll ball, a scroll bar, buttons, a barcode scanner, etc. Further, outputs from the OTDR device 302 may be displayed on one or more display devices of the I/O interfaces 354 (e.g., a liquid crystal display (LCD), touch screen, etc.). The I/O interfaces 354 may include a graphical user interface (GUI) that enables a user to interact with the OTDR device 302.

The network interface 356 may enable wireless communication to an external access device or network. Any number of suitable wireless data communication protocols, techniques, or methodologies may be supported by the network interface 356.

The data store 358 may be used to store data, such as OTDR traces and/or OTDR measurement data files. In some embodiments, the data store 358 may include any of volatile memory elements (e.g., RAM), nonvolatile memory elements (e.g., ROM), and/or combinations thereof. Moreover, the data store 358 may incorporate electronic, magnetic, optical, and/or other types of storage media.

The memory 360 may include any of volatile memory elements (e.g., RAM), nonvolatile memory elements (e.g., ROM), and/or combinations thereof. Moreover, the memory 360 may incorporate electronic, magnetic, optical, and/or other types of storage media. In some embodiments, the memory 360 may have a distributed architecture, where various components are situated remotely from one another, but can be accessed by the processor 352. The computer-readable instructions stored within memory 360 can include one or more computer programs 366, each of which may include one or more ordered listings of executable instructions for implementing logical functions. As illustrated, memory 360 may include an operating system (O/S) 364 in addition to computer programs 366. The operating system 364 may control the execution of other computer programs 366 and/or provide scheduling, input-output control, file and data management, memory management, and communication control and related services.

The programs 366 may include various applications, add-ons, etc. configured to provide end-user functionality with the OTDR device 302. For example, programs 366 may include a web browser to connect with a server for transferring OTDR measurement data files and/or a dedicated OTDR application configured to control OTDR acquisitions by the OTDR acquisition device 308, set OTDR acquisition parameters, analyze OTDR traces obtained by the OTDR acquisition device 308, and display a GUI related to the OTDR device 302. For example, the dedicated OTDR application may include an OTDR analysis module configured to analyze acquired OTDR traces in order to characterize the optical fiber under test, and produce OTDR measurement data files.

It is noted that, in some embodiments, the I/O interfaces 354 may be provided by a physically distinct mobile device (not illustrated), such as a handheld computer, a smartphone, a tablet computer, a laptop computer, a wearable computer etc. For example, a mobile device may be communicatively coupled to the OTDR device 302 via the network interface 356. In such cases, at least some of the programs 366 may be located in a memory of such a mobile device, for execution by a processor of the mobile device. Further, in some embodiments, the mobile device may also include a network interface used to transfer OTDR measurement data files 310 to a server 314.

The OTDR device 302 shown and described with reference to FIGS. 3A and 3B is provided solely as an example. Additional and alternative components for the OTDR device 302 are also possible and are contemplated herein.

FIG. 3C is a block diagram illustrating an OTDR acquisition device (e.g., the OTDR acquisition device 308 shown and described with reference to FIGS. 3A and 3B). As illustrated in FIG. 3A, the OTDR acquisition device 308 may be connectable to an optical fiber 320 in order to perform one or more OTDR measurements. For example, the OTDR acquisition device 308 may be connected via an output interface 378 to the optical fiber 320 in order to perform OTDR acquisitions. The OTDR acquisition device 308 may include optical hardware and electronics in order to perform OTDR measurements of the optical fiber 320. For example, the OTDR acquisition device 308 may include a light generating assembly 380, a detection assembly 390, a directional coupler 376, a controller 372, and a data store 374.

The light generating assembly 380 may include a laser source 384 that is driven by a pulse generator 382 to generate an OTDR test signal that includes test light pulses having one or more predefined characteristics. The light generating assembly 380 may be configured to generate test light pulses of varied pulse widths, repetition periods, and/or optical powers through control of the pattern produced by the pulse generator 382. In some cases, different OTDR measurements may be performed at different wavelengths. For this reason, in some embodiments, the light generating assembly 380 may be configured to generate test light pulses that have different wavelengths by including a tunable laser source 384. In some embodiments, the light generating assembly 380 may include both pulse width and wavelength control capabilities. In some embodiments, the light generating assembly 380 may include additional or alternative components, such as modulators, lenses, mirrors, optical filters, wavelength selectors, etc.

The light generating assembly 380 may be coupled to the output interface 378 of the OTDR acquisition device 308 through a directional coupler 376 (e.g., a circulator) that has three or more ports. The first port may be connected to the light generating assembly 380 to receive the test light pulses therefrom. The second port may be connected to the output interface 378. The third port may be connected to the detection assembly 390. The connections may be arranged such that test light pulses generated by the light generating assembly 380 are coupled to the output interface 378 and the return light signal arising from backscattering and reflections along the optical fiber 320 is coupled to the detection assembly 390.

As illustrated in FIG. 3C, the detection assembly 390 may include a light detector 394 (e.g., a photodiode, an avalanche photodiode, or any other suitable photodetector) that detects the return light signal corresponding to each test light pulse and an analog-to-digital converter 392 to convert the electrical signal proportional to the detected return light signal from analog to digital in order to allow data storage and processing. In some embodiments, the detected return light signal may be amplified, filtered, or otherwise processed before analog to digital conversion. The power level of returning light signals as a function of time (e.g., which is obtained from the detection and conversion described above) may be referred to as one acquisition of an OTDR trace. In the context of OTDR, each light acquisition may involve propagating a large number of substantially identical light pulses in the optical fiber 320 and averaging the results in order to improve the signal-to-noise ratio (SNR). In such cases, the result obtained from averaging may be referred to herein as an OTDR trace.

The OTDR acquisition device 308, and more specifically the light generating assembly 380 may be controlled by the controller 372. The controller 372 may include a hardware logic device. As such, the controller 372 may include one or more field programmable gate array (FPGAs), one or more application specific integrated circuits (ASICs), or one or more processors configured with a state machine or stored program instructions. When the OTDR acquisition device 308 is in operation, the controller 372 may be configured to control the OTDR measurement process. The controller 372 may control parameters of the light generating assembly 380 according to OTDR acquisition parameters that are either provided by the operator of the OTDR software or otherwise determined by program(s) 366.

The data store 374 may be used to accumulate raw data received from the detection assembly 390, as well as intermediary averaged results and resulting OTDR traces. The data store 374 may include any volatile memory elements (e.g., RAM). Further, the data store 374 may be embedded with or separate from the controller 372. The OTDR traces acquired by the OTDR acquisition device 308 may be received and analyzed by one or more of the computer programs 366 and/or stored in data store 358 for future processing.

The architecture of the OTDR acquisition device 308 is provided solely as an example. Numerous types of optical and electronic components are available and can be used to implement the OTDR acquisition device 308 in alternative embodiments.

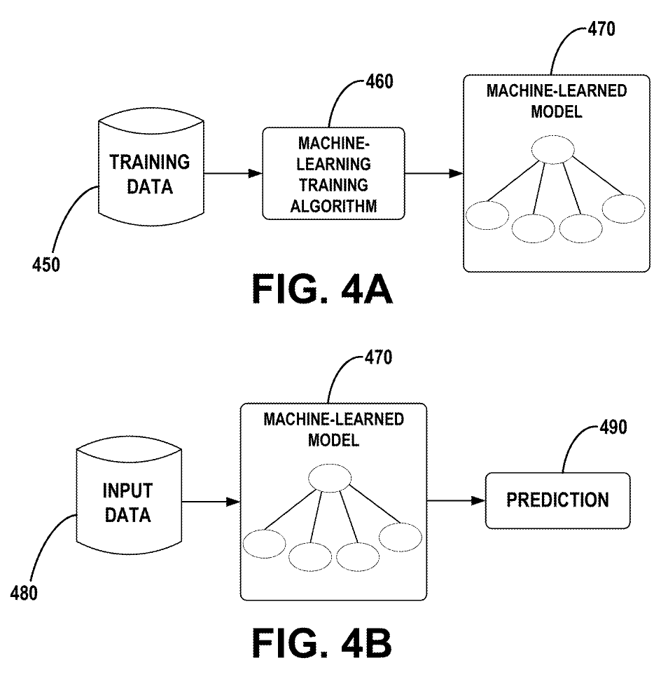

FIG. 4A illustrates a method of training a machine-learned model 470 (e.g., an ANN, such as a deep ANN; a generative adversarial network (GAN); or a support vector machine), according to example embodiments. The method of FIG. 4A may be performed by a computing device (e.g., the computing device 100 illustrated in FIG. 1), in some embodiments. As illustrated, the machine-learned model 470 may be trained using a machine-learning training algorithm 460 based on training data 450 (e.g., based on patterns within the training data 450). While only one machine-learned model 470 is illustrated in FIGS. 4A and 4B, it is understood that multiple machine-learned models could be trained simultaneously and/or sequentially and used to perform the predictions described herein. For example, in the case of a GAN, one or more generators and one or more discriminators could be simultaneously trained. Ultimately, a prediction 490 may be made using the trained machine-learned model 470. For example, the machine-learned model 470 may be used (e.g., by the computing device 100) to determine locations, reflectance values, and loss values associated with discrete reflective events (e.g., connectors) along the optical fiber; a location of an end of the optical fiber; and/or locations and loss values associated with splices along the optical fiber.

The machine-learned model 470 may include, but is not limited to: one or more ANNs (e.g., one or more convolutional ANNs, one or more recurrent ANNs, one or more Bayesian networks, one or more hidden Markov models, one or more Markov decision processes, one or more logistic regression functions, one or more suitable statistical machine-learning algorithms, one or more heuristic machine-learning systems, one or more GANs, etc.), one or more support vector machines, one or more regression trees, one or more ensembles of regression trees (i.e., regression forests), one or more decision trees, one or more ensembles of decision trees (i.e., decision forests), and/or some other machine-learning model architecture or combination of architectures.

The machine-learning training algorithm 460 may involve supervised learning, semi-supervised learning, reinforcement learning, and/or unsupervised learning. Similarly, the training data 450 may include labeled training data and/or unlabeled training data. Further, as described above with respect to the machine-learned model 470, a number of different machine-learning training algorithms 460 could be employed herein. If the machine-learned model 470 includes a GAN, the machine-learning training algorithm 460 may include training one or more discriminator ANNs and one or more generator ANNs based on the training data 450.

Additionally, the machine-learning training algorithm 460 may be tailored and/or altered based on the machine-learned model 470 to be generated (e.g., based on desired characteristics of the output machine-learned model 470). Further, the training data 450 may be used to train the machine-learned model 470 using the machine-learning training algorithm 460. For example, the machine-learned model 470 may embed labeled training data that is used to train the machine-learned model 470. For instance, training discriminator(s) / generator(s) may occur in a supervised fashion using labeled training data and/or using sample input training data for the generator(s). Further, in some embodiments, the machine-learning training algorithm 460 may enforce rules during the training of the machine-learned model 470 through the use of one or more hyperparameters.

Once the machine-learned model 470 is trained by the machine-learning training algorithm 460 (e.g., using the method of FIG. 4A), the machine-learned model 470 may be used to make one or more predictions (i.e., inferences). For example, a computing device (e.g., the computing device 100 shown and described with reference to FIG. 1), may make a prediction 490 using the machine-learned model 470 based on input data 480, as illustrated in FIG. 4B.

The training data 450 used to train a machine-learned model 470 as described herein may include a series of previously captured OTDR traces as an input and locations and characteristics about reflective events and splices as outputs. Additionally or alternatively, the training data 450 may include synthetic OTDR traces (e.g., OTDR traces generated by an OTDR simulator) as an input and locations and characteristics about reflective events and splices as outputs. In some embodiments, pairs of OTDR traces / locations and characteristics about reflective events and splices may be used to robustly train the machine-learned models 470 described herein. Likewise, in some embodiments, measured or synthetic OTDR traces may be used as training data 450 (e.g., with a single, ground truth OTDR trace as a desired output that also constitutes a portion of the training data 450). Additionally or alternatively, in some embodiments, machine-learned models 470 described herein may be continuously updated as they are used. For example, upon additional OTDR traces being captured and processed by an OTDR device (e.g., the OTDR device 302 shown and described with reference to FIGS. 3A and 3B), the machine-learned model 470 may be re-trained using the additional OTDR traces as new training data 450 (e.g., in addition to the previously used training data 450). Additionally or alternatively, synthetic OTDR traces (e.g., OTDR traces generated by an OTDR simulator) may be used as new training data 450 to re-train the machine-learned model 470. Such additional training may be performed by the OTDR device 302 or by a separate computing device (e.g., a server device, a cloud device, a mobile device, a tablet device, etc.).

While the same computing device (e.g., a computing device 100 as in FIG. 1) may be used to both train the machine-learned model 470 (e.g., as illustrated in FIG. 4A) and make use of the machine-learned model 470 to make a prediction 490 (e.g., as illustrated in FIG. 4B), it is understood that this need not be the case. In some embodiments, for example, a computing device may execute the machine-learning training algorithm 460 to train the machine-learned model 470 and may then transmit the machine-learned model 470 to another computing device for use in making one or more predictions 490. In the context of this disclosure, for example, a computing device may be used to initially train the machine-learned model 470 and then this machine-learned model 470 could be stored for later use.

FIG. 5A is a block diagram illustrating a technique 501 for detecting splices using an ensemble of machine-learned models 516 based on a plurality of OTDR acquisitions. The technique 501 illustrated in FIG. 5A may be performed using the system 300 illustrated in FIG. 3A (e.g., including the OTDR device 302), a client device (e.g., a mobile device, personal computer, laptop computer, or tablet device of an optical engineer and/or technician), a server device (e.g., the server devices 202 shown and described with reference to FIG. 2), and/or a computing device (e.g., the computing device 100 shown and described with reference to FIG. 1). As illustrated, the technique 501 may include receiving and processing a plurality of OTDR acquisitions 512. The OTDR acquisitions 512 may characterize a single underlying optical fiber under test, for example. In some cases, each OTDR acquisition of the plurality of OTDR acquisitions 512 may include at least 10,000 discrete points (e.g., each corresponding to a discrete acquisition by a photodetector, such as the light detector 394 shown and described with reference to FIG. 3C). Further, in some embodiments, the pulse widths of the respective light pulses propagated through the optical fiber under test (e.g., based on illuminations from a light source, such as the laser source 384 shown and described with reference to FIG. 3C) to generate the OTDR acquisitions 512 may each be at most 5 ns. Other values are also possible (e.g., at most 1 ns, at most 2 ns, at most 3 ns, at most 4 ns, at most 6 ns, at most 10 ns, at most 7 ns, at most 8ns, at most 9 ns, at most 10 ns, at most 25 ns, at most 50 ns, at most 75 ns, at most 100 ns, etc.). Additionally, or alternatively, the OTDR acquisitions 512 may each be captured over a predefined acquisition time per trace (e.g., 60 s, 30 s, 10 s, 5 s, 4 s, 3 s, 2 s, 1 s, 0.5 s, 0.1 s, etc.).

As illustrated in FIG. 5A, the technique 501 may include receiving the plurality of OTDR acquisitions 512 as an input. These OTDR acquisitions may then be synthesized into one or more OTDR traces 513 (e.g., by averaging subsets of the OTDR acquisitions 512).

FIG. 5B schematically illustrates synthesizing OTDR acquisitions into multiple OTDR traces 513. By way of example, subsets of the OTDR acquisitions may be separated based on acquisition time. For instance, a first subset of the OTDR acquisitions 512A may include acquisitions that were captured between a first point in time, t₁, and a second point in time, t₂. In example embodiments, the difference between the second point in time and the first point in time may be between 0.5 s and 1.5 s. Other values are also possible. The first subset of OTDR acquisitions 512A may then be synthesized into a single OTDR trace 513A, such as by calculating a mean of the first subset of the OTDR acquisitions 512A. Other statistical methods may be used to synthesize the OTDR trace 513A. For example, the method may include calculating a standard deviation of the subset of the OTDR acquisitions, calculating a first derivative of the subset of the OTDR acquisitions, and/or detrending the subset of the OTDR acquisitions.

Similarly, FIG. 5B illustrates a second subset of OTDR acquisitions 512B that includes acquisitions that were captured between a third point in time, t₃, and a fourth point in time, t_{4.} The second subset of OTDR acquisitions 512B may then be synthesized into a single OTDR trace 513B, such as by calculating a mean of the second subset of the OTDR acquisitions 512B.

While FIG. 5B illustrates the second point in time and the third point in time as distinct, in some example embodiments, the second point in time and the third point in time may coincide with one another, such that the first subset and the second subset correspond to contiguous ranges of time. Further, while FIG. 5B illustrates only two subsets of OTDR acquisitions being synthesized into two OTDR traces, in example embodiments the OTDR acquisitions may be split into several different subsets, forming several separate OTDR traces. By way of example, a 10 s OTDR acquisition may be split into ten separate 1 s subsets. This approach of splitting OTDR acquisitions into multiple smaller, averaged acquisitions may improve the ability to differentiate between signals corresponding to events in the fiber and measurement noise.

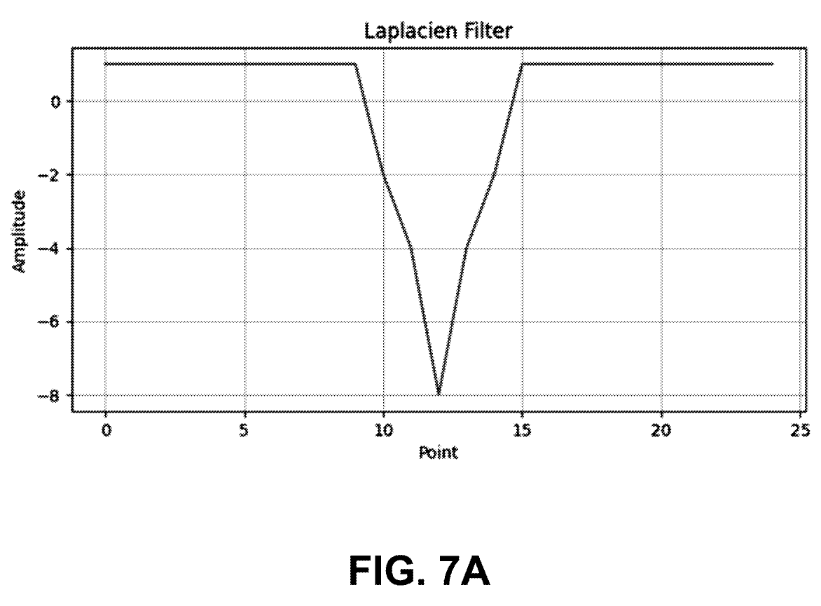

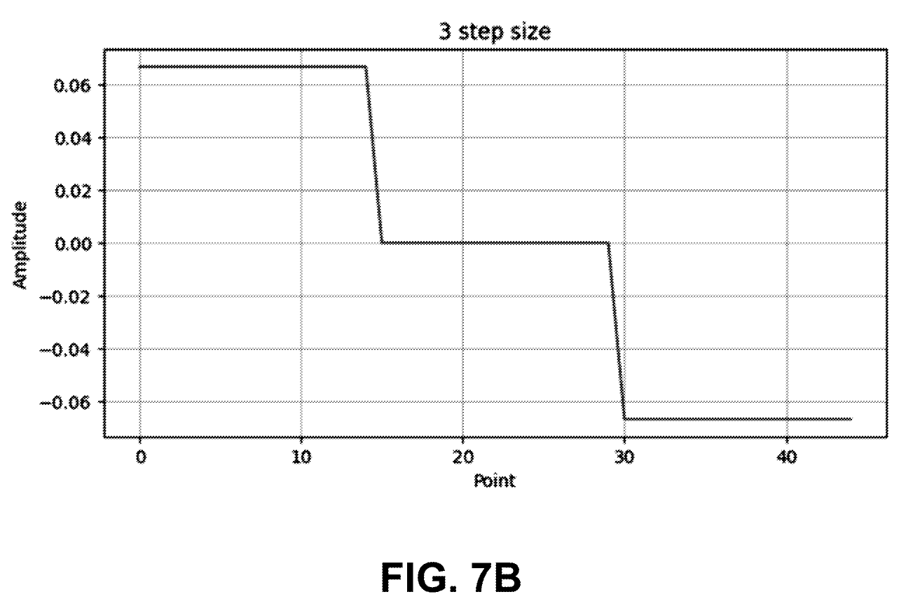

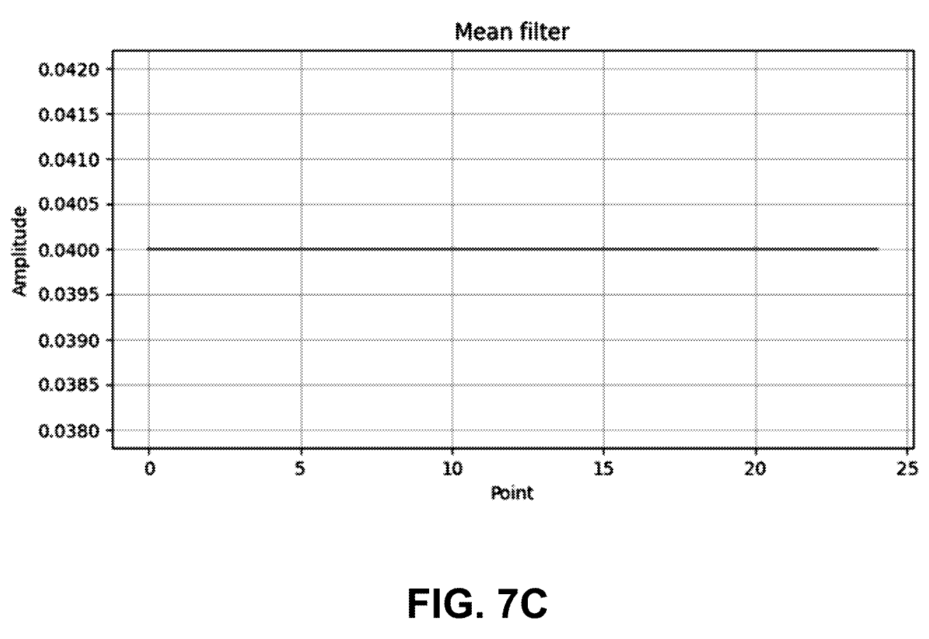

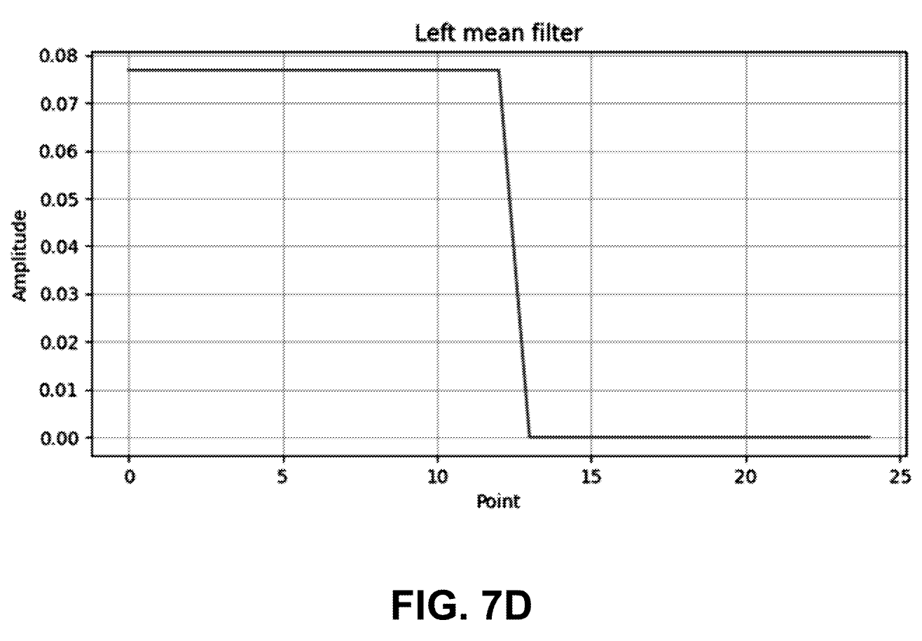

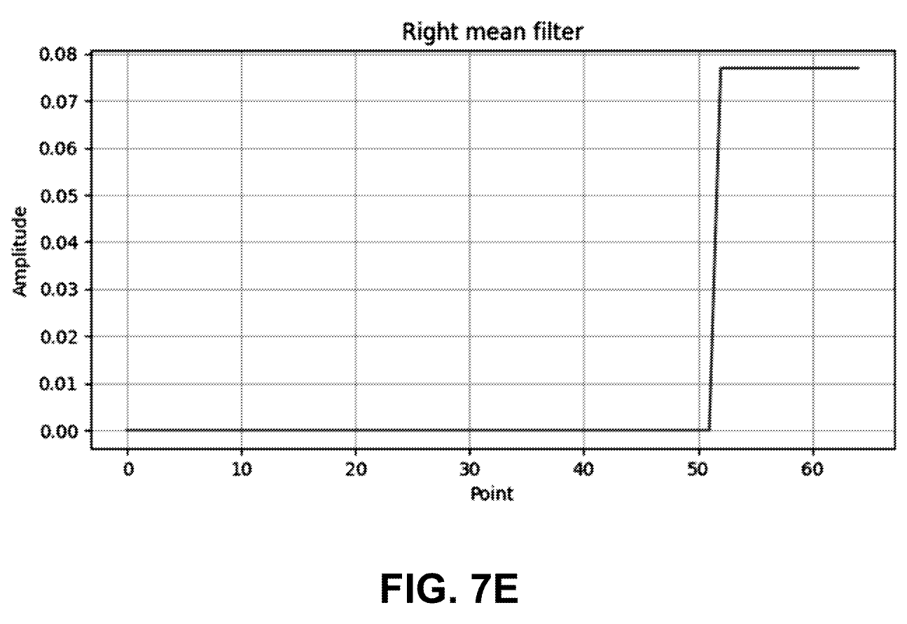

In some embodiments, the synthesized OTDR traces may be provided to one or more preprocessors 514. The preprocessors 514 may be configured to alter the OTDR traces in various disparate ways in order to enhance certain features to be detected by respective machine-learned models downstream in the ensemble of machine-learned models 516. Example preprocessors 514A, 514B, 514C, 514D, 514E, 514F, 514G will be shown and described in greater detail below with respect to FIGS. 5C and 7A-7E. The example preprocessors illustrated herein include filters for convolving with the OTDR trace(s) 513.

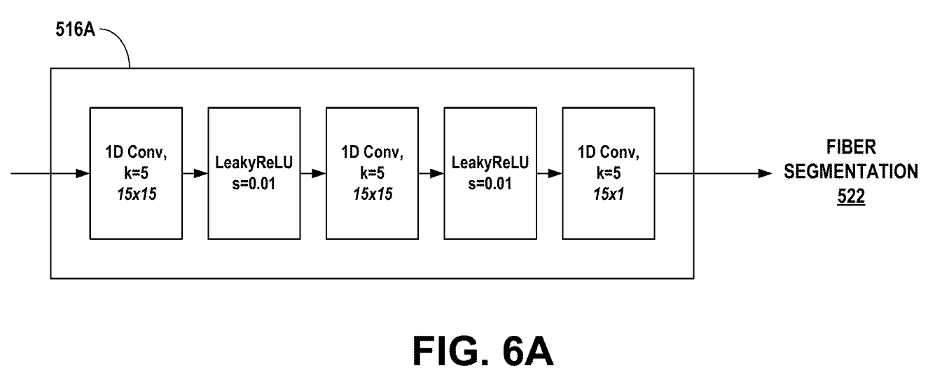

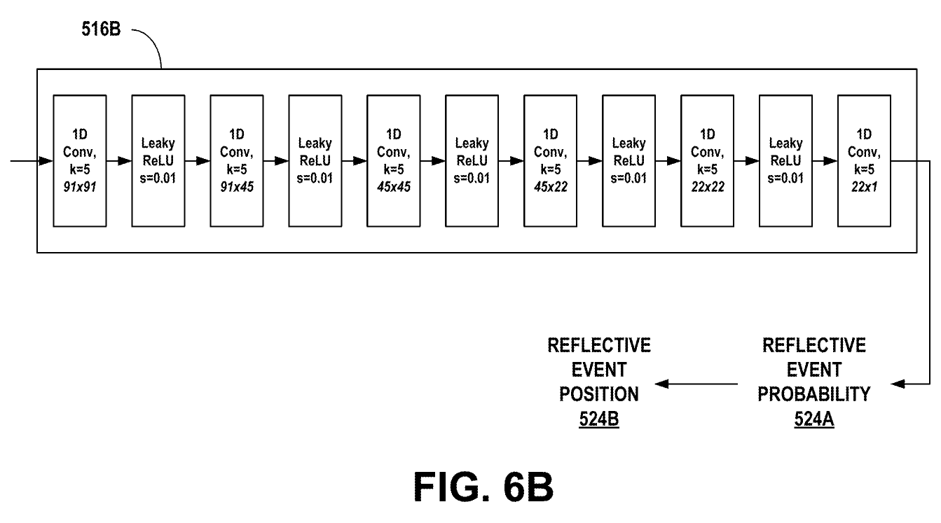

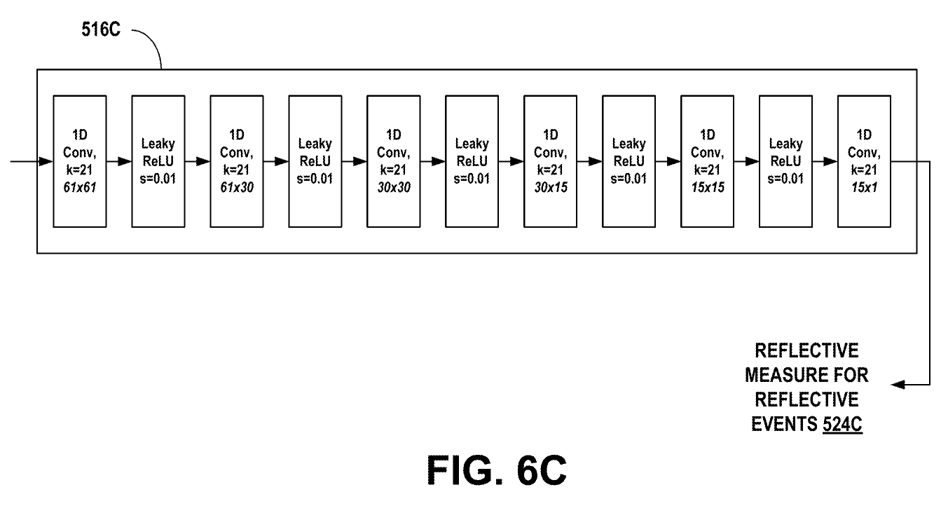

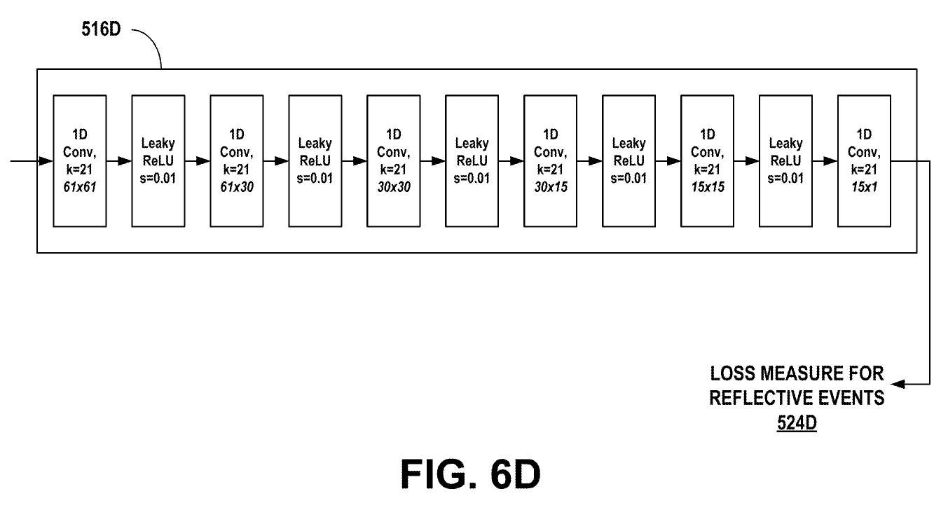

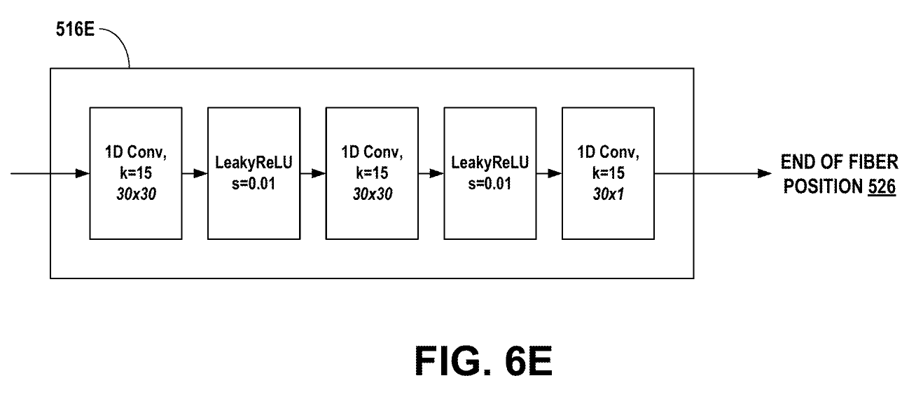

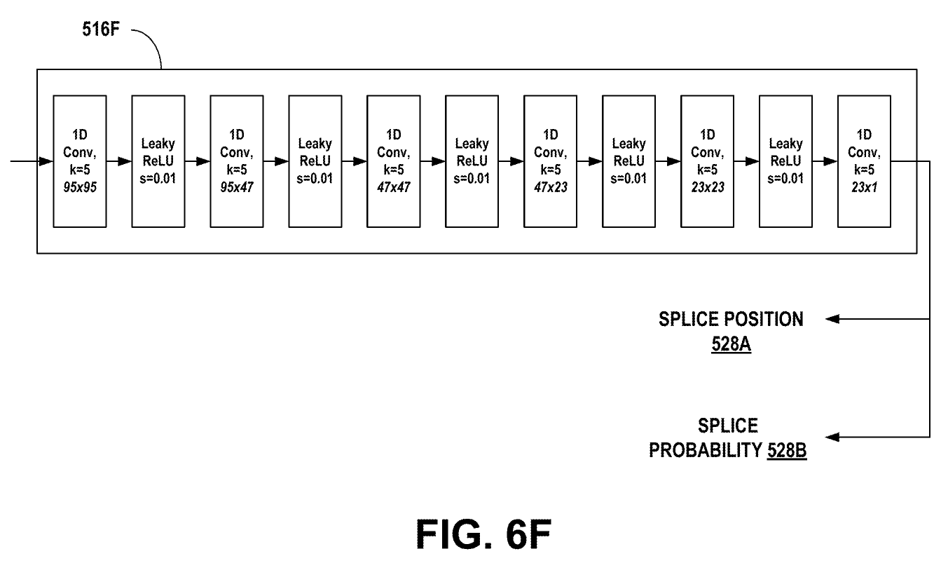

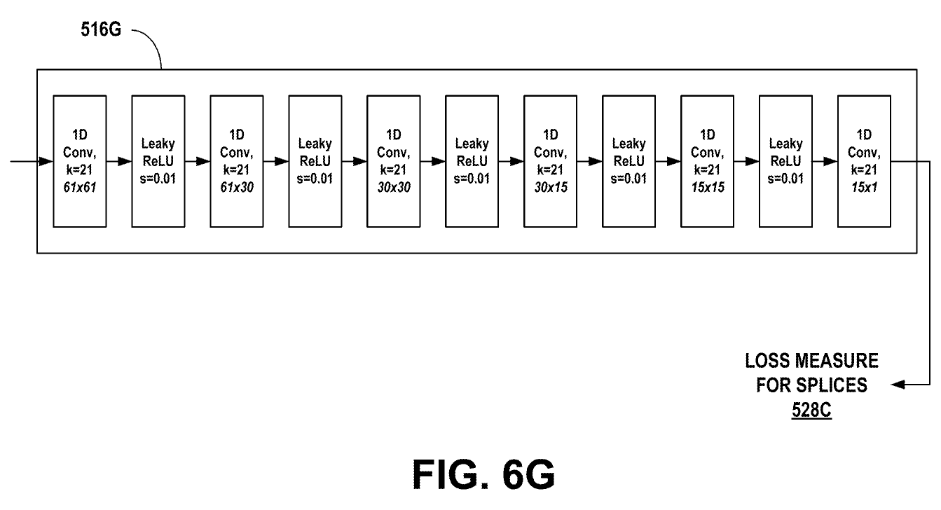

Next, all of the synthesized OTDR traces 513 (with or without preprocessing) or a subset of the OTDR traces 513 (with or without preprocessing) may be provided to an ensemble of machine-learned models 516 (e.g., an ensemble of ANNs). The ensemble of machine-learned models 516 may include various individual machine-learned models that have been trained for specific purposes. Example machine-learned models will be shown and described in greater detail below with respect to FIGS. 5C and 6A-6G. By way of example, the ensemble of machine-learned models 516 may include a segmentator 516A, a reflective event detector 516B, a reflective event measurer 516C, a reflective event loss measurer 516D, an end of fiber detector 516E, a splice event detector 516F, and/or a splice loss measurer 516G.

The ensemble of machine-learned models 516 may work together to identify and characterize various events along the optical fiber. As illustrated in FIG. 5A, the ensemble of machine-learned models 516 may provide splice position(s) 528A (i.e., the location(s) of one or more splices along the optical fiber) and the associated loss measure(s) for splices 528C. While FIG. 5A illustrates only splice information being provided, this method may be extended to provide information about reflective event(s) (e.g., reflective event position(s) 524B, reflective measure(s) for reflective events 524C, and loss measure(s) for reflective events 524D). Similarly, this method may be used to determine the end of fiber position 526.

FIG. 5C is a block diagram illustrating an example embodiment of a technique 502 for detecting reflective events and splices based on a plurality of OTDR acquisitions using an ensemble of machine-learned models 516. The technique 502 may be variation of the technique 501 shown and described with FIG. 5A.

The technique 502 may include receiving OTDR acquisitions 512 as described above in relation to FIG. 5A. The OTDR acquisitions 512 may then be synthesized into one or more traces and provided to one or more preprocessors 514A, 514B, 514C, 514D, 514E, 514F, 514G. The OTDR traces may then be provided to a variety of different machine-learned models 516A, 516B, 516C, 516D, 516E, 516F, 516G.

For example, as illustrated in FIG. 5C, one or more OTDR traces may be provided to segmentator 516A. Segmentator 516A may include an ANN that is trained to generate, based on input OTDR traces, a segmentation mask (i.e., a fiber segmentation 522) that distinguishes between portions of the OTDR trace(s) that correspond to locations within the optical fiber under test and portions of the OTDR trace(s) that correspond to locations beyond the optical fiber under test (e.g., represent distances beyond the end of the optical fiber under test). The fiber segmentation 522 may then be supplied to a reflective event detector 516B, a reflective event measurer 516C, a reflective event loss measurer 516D, an end of fiber detector 516E, a splice event detector 516F, and a splice loss measurer 516G. While the technique 502 illustrated in FIG. 5C generates an upfront fiber segmentation 522 using the segmentator 516A, other embodiments are also possible. For example, in some embodiments, one or more of the OTDR traces may first be fed directly into the reflective event detector 516B (or into the reflective event detector 516B via preprocessor 514B). Likewise, the reflective event detector 516B, reflective event measurer 516C, reflective event loss measurer 516D, end of fiber detector 516E, splice event detector 516F, and splice loss measurer 516G may be trained so that they do not require the fiber segmentation 522 in order to generate outputs based on input OTDR trace(s). In some embodiments, however, by including the segmentator 516A, the detection probabilities of reflective events and splices generated by the ensemble of machine-learned models 516 may have improved accuracy. Regardless of the presence or absence of the segmentator 516A, the end of fiber detector 516E may still be used to provide information regarding the end of fiber position 526.

The reflective event detector 516B may include a machine-learned model (e.g., an ANN) trained to determine a set of probabilities indicative of potential reflective events (i.e., reflective event probability 524A) along the length of the optical fiber under test. The reflective event detector 516B may determine the reflective event probability 524A based on one or more OTDR traces (with or without preprocessing) and the fiber segmentation 522. Once determined by the reflective event detector 516B, the reflective event probability 524A may be compared to one or more probability thresholds. At locations along the optical fiber under test where the reflective event probability 524A is greater than a given probability threshold (e.g., greater than 50%, greater than 75%, greater than 90%, greater than 95%, greater than 99%, etc.), reflective event positions 524B may be identified (e.g., and displayed on a user interface). Further, the reflective event probability 524A may also be provided to the reflective event measurer 516C, the reflective event loss measurer 516D, the end of fiber detector 516E, the splice event detector 516F, and the splice loss measurer 516G.

The reflective event measurer 516C may include a machine-learned model (e.g., an ANN) trained to determine a reflective measure for each of the reflective events 524C along the optical fiber under test. The reflective measurement may indicate a reflectance of the reflective events (e.g., connectors) along the optical fiber under test. As such, the reflective measure for each of the reflective events 524C may be usable to identify defects within the optical fiber under test (e.g., broken or defective connectors). The reflective event measurer 516C may determine the reflective measure for each of the reflective events 524C based on one or more OTDR traces (with or without preprocessing), the fiber segmentation 522, and the reflective event probability 524A.

The reflective event loss measurer 516D may include a machine-learned model (e.g., an ANN) trained to determine a loss measure for each of the reflective events 524D along the optical fiber under test. The loss measurement may indicate an optical loss of the reflective events (e.g., connectors) along the optical fiber under test. As such, the loss measure for each of the reflective events 524D may be usable to identify defects within the optical fiber under test (e.g., broken or defective connectors). The reflective event loss measurer 516D may determine the loss measure for each of the reflective events 524D based on one or more OTDR traces (with or without preprocessing), the fiber segmentation 522, and the reflective event probability 524A.

The end of fiber detector 516E may include a machine-learned model (e.g., an ANN) trained to determine a refined end of fiber position 526 for the optical fiber under test. The end of fiber position 526 may indicate a location along the optical fiber under test where the fiber terminates. Whereas the fiber segmentation 522 mask may include a coarse approximation of the end of the fiber (e.g., an approximation that is slightly more susceptible to noise), the end of fiber position 526 may be of higher precision. The end of fiber detector 516E may determine the end of fiber position 526 based on one or more OTDR traces (with or without preprocessing), the fiber segmentation 522, and the reflective event probability 524A.

The splice event detector 516F may include a machine-learned model (e.g., an ANN) trained to determine a set of probabilities indicative of potential splices (i.e., splice probability 528B) along the length of the optical fiber under test and splice position(s) 528A along the length of the optical fiber. In some embodiments, the splice position(s) 528A may be determined by the splice event detector 516F by comparing the set of probabilities indicative of potential splices (i.e., splice probability 528B) to one or more probability thresholds. The splice event detector 516F may determine the splice position 528A and the splice probability 528B based on one or more OTDR traces (with or without preprocessing), the fiber segmentation 522, and the reflective event probability 524A. Upon determining the splice probability 528B, the splice probability 528B may be provided to the splice loss measurer 516G.

The splice loss measurer 516G may include a machine-learned model (e.g., an ANN) trained to determine a loss measure for each of the splices 528C along the optical fiber under test. The loss measurement may indicate an optical loss of the splices along the optical fiber under test. As such, the loss measure for each of the splices 528C may be usable to identify defects within the optical fiber under test (e.g., broken or defective splices). The splice loss measurer 516G may determine the loss measure for each of the splices 528C based on one or more OTDR traces (with or without preprocessing), the fiber segmentation 522, the reflective event probability 524A, and the splice probability 528B.

In some embodiments, the techniques 501 and 502 may be used to analyze a malfunctioning fiber splice associated with the optical fiber under test and/or a malfunctioning connector associated with the optical fiber under test. For example, the techniques 501 and 502 may be used to determine a location along the optical fiber under test of the malfunctioning fiber splice or of the malfunctioning connector. In example embodiments, determining that a splice is malfunctioning may be based on the loss values associated with the splice. Similarly, determining that a connector is malfunctioning may be based on reflective values and/or loss values associated with the connector. Based on such determinations, a remedial action may be performed. For example, the malfunctioning fiber splice, the malfunctioning connector, and/or the entire optical fiber under test may be repaired, replaced, or decommissioned.

FIG. 6A is a block diagram illustrating the segmentator 516A shown and described with reference to FIG. 5C, according to example embodiments. As illustrated, the segmentator 516A may be an ANN that includes a filter stack. For example, the filter stack may include three layers and two activation functions. The kernel sizes are denoted by the k values in the different layers. A “1D Conv” layer is understood to represent a one-dimensional, convolutional ANN layer. Similarly, an MxN value in a layer is understood to represent the channels present in a given layer. Other model architecture is also possible. Further, a “LeakyReLU” is understood to represent a leaky rectified linear unit activation function. Additional or alternative activation functions are also possible (e.g., a rectified linear unit activation function (“ReLU”), an exponential linear unit activation function (“ELU”), or a Gaussian error linear unit activation function (“GELU”)). Additionally, other numbers of layers, other numbers of activation functions, other types of layers (e.g., layers with different kernel sizes), and other types of activation functions are also possible.

FIG. 6B is a block diagram illustrating the reflective event detector 516B shown and described with reference to FIG. 5C, according to example embodiments. As illustrated, the reflective event detector 516B may be an ANN that includes a filter stack. For example, the filter stack may include six layers and five activation functions. Other numbers of layers, other numbers of activation functions, other types of layers (e.g., layers with different kernel sizes), and other types of activation functions are also possible.

FIG. 6C is a block diagram illustrating the reflective event measurer 516C shown and described with reference to FIG. 5C, according to example embodiments. As illustrated, the reflective event measurer 516C may be an ANN that includes a filter stack. For example, the filter stack may include six layers and five activation functions. Other numbers of layers, other numbers of activation functions, other types of layers (e.g., layers with different kernel sizes), and other types of activation functions are also possible.

FIG. 6D is a block diagram illustrating the reflective event loss measurer 516D shown and described with reference to FIG. 5C, according to example embodiments. As illustrated, the reflective event loss measurer 516D may be an ANN that includes a filter stack. For example, the filter stack may include six layers and five activation functions. Other numbers of layers, other numbers of activation functions, other types of layers (e.g., layers with different kernel sizes), and other types of activation functions are also possible.

FIG. 6E is a block diagram illustrating the end of fiber detector 516E shown and described with reference to FIG. 5C, according to example embodiments. As illustrated, the end of fiber detector 516E may be an ANN that includes a filter stack. For example, the filter stack may include three layers and two activation functions. Other numbers of layers, other numbers of activation functions, other types of layers (e.g., layers with different kernel sizes), and other types of activation functions are also possible.

FIG. 6F is a block diagram illustrating the splice event detector 516F shown and described with reference to FIG. 5C, according to example embodiments. As illustrated, the splice event detector 516F may be an ANN that includes a filter stack. For example, the filter stack may include six layers and five activation functions. Other numbers of layers, other numbers of activation functions, other types of layers (e.g., layers with different kernel sizes), and other types of activation functions are also possible.

FIG. 6G is a block diagram illustrating the splice loss measurer 516G shown and described with reference to FIG. 5C, according to example embodiments. As illustrated, the splice loss measurer 516G may be an ANN that includes a filter stack. For example, the filter stack may include six layers and five activation functions. Other numbers of layers, other numbers of activation functions, other types of layers (e.g., layers with different kernel sizes), and other types of activation functions are also possible.

FIGS. 7A-7E are example preprocessors 514A, 514B, 514C, 514D, 514E, 514F, 514G, according to example embodiments. The preprocessors illustrated in FIGS. 7A-7E may be filters that are convolved with OTDR trace(s) synthesized from the OTDR acquisitions 512 prior to the OTDR trace(s) being provided to the ensemble of machine-learned models 516. The different preprocessors 514A, 514B, 514C, 514D, 514E, 514F, 514G may apply different filters to reduce noise and/or to emphasize different characteristics of the OTDR trace(s) (e.g., to enhance the results produced by the subsequent machine-learned models).

FIG. 7A is an illustration of a Laplacian filter configured to extract features where there are peaks in the OTDR trace(s). FIG. 7B is a step size filter with three steps. The points along the middle step having an amplitude of zero may be ignored. This filter may be configured to determine if there is a step (loss) while ignoring possible peaks, such as from connectors. FIG. 7C is a mean filter (illustrated in this example embodiment with 25 points). The mean filter may filter noise by using the mean of the points. FIG. 7D is a left mean filter. This filter may calculate the average of the points on the left while ignoring the points on the right. This can be used when measuring reflectance or loss. FIG. 7E is a right mean filter with a large gap. This filter may allow for the points on the left to be ignored. The gap may allow for ignoring peaks for reflective events. This filter may be used when measuring loss in reflective events. Other filters and/or other types of preprocessors (e.g., in addition to or instead of filters) are also possible.

### III.Experimental Results

FIGS. 8A – 8F illustrate results of an experimental investigation that was performed to assess the performance of the methods described herein.

FIG. 8A provides a table of parameters used to generate a dataset for detection with a 5 ns pulse width and a 10 second total acquisition time. Similarly, FIG. 8B provides a table of parameters used to generate a different dataset for detection with a 5 ns pulse width and a 30 second total acquisition time.

Example embodiments described herein include ensembles of machine-learned models (e.g., the ensemble of machine-learned models 516 described herein) trained to intake data from traces that were acquired for 10 seconds and 30 seconds, respectively. The results of these trained machine-learned models were then compared to results that use traditional techniques (i.e., a “classic model”) at 10 seconds and 30 seconds, respectively, in order to quantify improvements observed for the ensembles of machine-learned models described herein. The traditional techniques use cursors positioned algorithmically along the OTDR trace(s) to determine measures of distance, reflectance, and loss for various events along the optical fiber.

For each trace of this experimental investigation, four types of events were present. The first event in every trace was the launch level, which corresponds to the start of the optical fiber. The second event was the end of fiber, which designates where the fiber ends and there is no more signal. The third event was a connector, also known as a reflective event. This event has a peak (corresponding to a reflectance) and a loss component. The last event was a splice. A splice does not have a non-negligible reflective component, only a loss, which appears as a step function in the trace.

FIG. 8C compares the detection of the end of the fiber by traditional techniques and an ensemble of machine-learned models (e.g., the ensemble of machine-learned models 516 described herein) at 10 seconds and 30 seconds of acquisition time, respectively. As illustrated, the machine-learned models with a 30 second acquisition time accurately determined the end of the fiber in 69.9% of samples, compared to only 60.8% of samples for the traditional techniques with a 30 second acquisition time. Likewise, the machine-learned models with a 10 second acquisition time accurately determined the end of the fiber in 52.4% of samples, compared to only 40.8% for the traditional techniques with the same acquisition time. Thus, it was observed that longer acquisition times result in enhanced detection. It was also observed that the ensemble of machine-learned models (e.g., the ensemble of machine-learned models 516 described herein) had an improved performance when compared to the traditional techniques.

FIG. 8D compares the detection of reflective events (i.e., the connectors) by traditional techniques and ensembles of machine-learned models (e.g., the ensemble of machine-learned models 516 described herein) at 10 seconds and 30 seconds of acquisition time, respectively. As illustrated in FIG. 8D, the machine-learned models accurately detected the connectors in 97.3% of samples for the 30 second acquisition time, and in 96.9% of samples for the 10 second acquisition time. By comparison, the traditional methods only accurately detected the connectors in 92.5% of samples for the 30 second acquisition time and in 89.2% of samples for the 10 second acquisition time. Thus, here it was observed that the ensemble of machine-learned models (e.g., the ensemble of machine-learned models 516 described herein) had an improved performance when compared to the traditional techniques for both acquisition times. Further, longer acquisition times resulted in enhanced detection.

FIG. 8E compares the detection of splices by traditional techniques and ensembles of machine-learned models (e.g., the ensemble of machine-learned models 516 described herein) at 10 and 30 seconds of acquisition time, respectively. As illustrated herein, the machine-learned models with a 30 second acquisition time accurately identified the splice in 62.2% of samples, whereas the traditional techniques at the same acquisition time only detected 50.8% of the splices. Additionally, the machine-learned models with a 10 second acquisition time accurately identified the splices in 45.1% of samples, while the traditional techniques for the 10 second dataset only identified 32.5% of splices. Similar to the trends observed in relation to FIG. 8C and 8D, it was observed that longer acquisition times resulted in enhanced detection and that the ensemble of machine-learned models (e.g., the ensemble of machine-learned models 516 described herein) had an improved performance when compared to the traditional techniques.

FIG. 8F summarizes the results of this experimental investigation described above with respect to FIGS. 8A – 8E. “TP” represents true positives, “FN” represents false negatives, “FP” represents false positives, and “PP” represents partial positives. Partial positives include events that were detected but misclassified and events that were detected with significant positional error. FIG. 8F shows that the ensemble of machine-learned models (e.g., the ensemble of machine-learned models 516 described herein) had enhanced performance compared with traditional techniques for any time acquisition on every metric, except the loss error measurement on splices. All positional and measurement errors tabulated in FIG. 8F represent average values. Overall, the ensemble of machine-learned models (e.g., the ensemble of machine-learned models 516 described herein) at 30 seconds had the best performance metrics. For reflective events, an improvement in detection, position, reflection measurement, and loss measurement was observed. For splices, improvements in detection and position were observed.

FIGS. 9A – 9O illustrate a second experimental investigation that was performed to assess the performance of the methods described herein. While the results shown in FIGS. 8A – 8F correspond to a pulse width of 5 ns, FIGS. 9A – 9O correspond to a pulse width of 100 ns. Further, the dataset corresponding to the ensemble of machine-learned models of FIGS. 9A – 9O was generated using a 10 second acquisition time.

FIG. 9A tabulates the parameters used for the dataset used with an ensemble of machine-learned models (e.g., the ensemble of machine learned models 516) for the experimental results shown in FIGS. 9B – 9O. Example embodiments include training an ensemble of machine-learned models to perform on the dataset generated from parameters in FIG. 9A. For example, an ensemble of machine-learned models may be trained to intake data from a trace that was acquired for 10 seconds and then compare it to traditional techniques (i.e., a classic model). Similar to the experiments described in conjunction with FIGS. 8A – 8F, there are four types of events present in each trace: the launch level, the end of fiber, a connector (reflective event), and a splice.

FIG. 9B shows the overall detections of the ensemble of machine-learned models (e.g., the ensemble of machine-learned models 516 described herein) compared to traditional techniques at 10 seconds and at 30 seconds, respectively. The leftmost (first) bars indicate the detections of traditional techniques at a 10 second acquisition trace. The same trace was then fed to the ensemble of machine-learned models (e.g., the ensemble of machine-learned models 516 described herein). The second bars with diagonal lines show the results of the ensemble of machine-learned models (e.g., the ensemble of machine-learned models 516 described herein). The third bars indicate the results of traditional techniques on a trace of 30 seconds. The solid black bar shows the ground truth of the events. As illustrated, the machine-learned models with a 10 second acquisition accurately detected 91.3% of all the events. By contrast, the traditional techniques only detected 83.5% and 79.0% of all events at 30 seconds and 10 seconds, respectively. Thus, the use of machine-learned models resulted in a 12% improvement in terms of true positives and a reduction of about 4.5% of false positives when compared to traditional techniques at 10 seconds. An improvement in the positional accuracy and the event classification was also observed. In addition to plotting the overall true positives (detections), FIG. 9B also provides the data for false negatives, false positives, instances where the event was detected with a high positional error, instances where the event was detected with a lower positional error, and instances where the event type was misclassified.

FIG. 9C shows the detection results for the launch levels which was the first event in the fiber. Each of the algorithms detected all of the launch levels and classified them correctly.

FIG. 9D shows the detection results for end of fibers. The leftmost (first) bars indicate the detections of traditional techniques at a 10 second acquisition. The same input was then fed to the ensemble of machine-learned models (e.g., the ensemble of machine-learned models 516 described herein). The second bars with diagonal lines show the results of the ensemble of machine-learned models (e.g., the ensemble of machine-learned models 516 described herein). The third bars with the vertical stripes indicate the results of traditional techniques on a trace of 30 seconds. The black bar shows the ground truth of the events. As illustrated, the machine-learned models accurately detected the end of the fiber in 90.7% of samples, whereas the traditional techniques accurately detected the end of the fiber in 85.6% of samples and 70.9% of samples for a 30 second acquisition and a 10 second acquisition, respectively. Thus, the ensemble of machine-learned models (e.g., the ensemble of machine-learned models 516 described herein) demonstrated a 20% improvement compared to traditional techniques at 10 seconds. As was shown in FIG. 9B, the data for false negatives, false positives, instances of high positional error, instances of low positional error, and instances of misclassified event types are plotted in FIG. 9D, as well. Here, the misclassified event type is further split into instances of misclassifying the end of fiber as a reflective event and instances of misclassifying the end of fiber as a splice. For all instances where the end of fiber was misclassified by traditional techniques, the end of the fiber was mistakenly classified as a reflective event.

FIG. 9E shows positional error of the end of fiber detection for traditional techniques at 10 seconds, the ensemble of machine-learned models at 10 seconds, and traditional techniques at 30 seconds. The top graph shows the distributions of the distance error in meters. The mean and standard deviation (in meters) were then calculated on the absolute error, which are plotted on the bottom two plots, respectively. The ensemble of machine-learned models (e.g., the ensemble of machine-learned models 516 described herein) had less positional errors when detecting the end of fiber compared to traditional techniques at 10 seconds and 30 seconds.

FIG. 9F shows positional error distribution of end of fiber determinations in relation to the SNR for traditional techniques at 10 seconds, the ensemble of machine-learned models (e.g., the ensemble of machine-learned models 516 described herein) at 10 seconds, and traditional techniques at 30 seconds. A lower SNR signifies that the end of fiber is in a noisier area of the trace. The values at the top of each SNR section indicate the number of instances/detections for each model. The “GT” corresponds to the ground truth, “input” corresponds to traditional techniques at 10 s, “ML” corresponds to the ensemble of machine-learned models at 10 s, and “gold” corresponds to traditional techniques at 30 s. The bottom plot corresponds to the ground truth number of events. FIG. 9F shows that positional improvement from the ensemble of machine-learned models (e.g., the ensemble of machine-learned models 516 described herein) was not impacted by the SNR. The ensemble of machine-learned models (e.g., the ensemble of machine-learned models 516 described herein) can also reliably classify the end of fibers in low SNR, whereas traditional techniques tend to be more adversely affected by a lower SNR.

FIG. 9G illustrates the detection results for reflective events (e.g., connectors). The leftmost bars correspond to the detections of traditional techniques at a 10 second acquisition. The second bars with diagonal lines indicate the results of the ensemble of machine-learned models (e.g., the ensemble of machine-learned models 516 described herein) at 10 seconds. The third, vertically lined bars show the results of traditional techniques on a trace of 30 seconds. The black bar shows the ground truth of the events. As illustrated, the machine-learned models with a 10 second acquisition time accurately detected the connectors in 89.7% of samples, compared with 84.5% for the traditional techniques with a 30 second acquisition time and 83.3% for the traditional techniques with a 10 second acquisition time. In the right plot, the false negatives, the false positives, the events with high positional error, the events with low positional error, the events that were detected but misclassified as end of fibers, and the events that were detected but misclassified as splices are plotted. All the algorithms demonstrated very few false positives. The ensemble of machine-learned models (e.g., the ensemble of machine-learned models 516 described herein) detected and classified more reflective events than traditional techniques (about 6% more). While the ensemble of machine-learned models (e.g., the ensemble of machine-learned models 516 described herein) also had more false negatives than traditional techniques, this distinction was not overly significant. Compared to traditional techniques, the major difference was that the ensemble of machine-learned models (e.g., the ensemble of machine-learned models 516 described herein) rendered an enhanced positioning and classification of the events, whereas traditional techniques had more positional mistakes and misclassifications as splices.

FIG. 9H shows the detection results of reflective events in accordance with the reflectance level in dB. A lower reflectance level signifies that the event has less of a peak and approaches more the characteristic of a splice. The detection of the reflective events by the ensemble of machine-learned models (e.g., the ensemble of machine-learned models 516 described herein) was impacted by the reflectance level of the event. As shown in FIG. 9H, it was observed that all the algorithms struggled the most with events having a small reflectance. The ensemble of machine-learned models (e.g., the ensemble of machine-learned models 516 described herein) had more true positives than the traditional techniques and significantly fewer misclassifications as splices.

FIG. 9I shows the detection results of reflective events in accordance with SNR. A lower SNR signifies that an event is in a noisier area of the trace. FIG. 9I shows that the traditional techniques do not depend on the SNR. The false negative rate appears constant across the SNR values, whereas the ensemble of machine-learned models’ (e.g., the ensemble of machine-learned models 516 described herein) false negatives and inaccurate detections occur in lower SNR. This may indicate that traditional techniques’ main struggle with reflective events detection occurs with a low reflectance and misclassifying those events as splices, whereas the ensemble of machine-learned models (e.g., the ensemble of machine-learned models 516 described herein) do not suffer from such a shortcoming. The ensemble of machine-learned models (e.g., the ensemble of machine-learned models 516 described herein) struggle with small reflective events with a low SNR.

FIG. 9J shows the positional error of the reflective events. The top graph shows the distributions of the distance error in meters. The mean and standard deviation were then calculated on the absolute error and plotted in the bottom two graphs, respectively. FIG. 9J shows that the position of the reflective events was more precise with the ensemble of machine-learned models (e.g., the ensemble of machine-learned models 516 described herein) than the traditional techniques.

FIG. 9K shows positional error distribution of reflective events in relation to the SNR. A lower SNR signifies that the reflective event is in a noisier area of the trace. The values at the top of each SNR section indicate the number of instances/detections for each model. The “GT” corresponds to the ground truth, “input” corresponds to traditional techniques at 10 s, “ML” corresponds to the ensemble of machine-learned models at 10 s, and “gold” corresponds to traditional techniques at 30 s. FIG. 9K shows that the SNR did not influence the positional error for traditional techniques or the ensemble of machine-learned models (e.g., the ensemble of machine-learned models 516 described herein).

FIG. 9L showcases the detection results for splices. The leftmost bars indicate the detections of traditional techniques at a 10 second acquisition. The second bars with diagonal lines show the results of the ensemble of machine-learned models (e.g., the ensemble of machine-learned models 516 described herein) at 10 seconds. The third, vertically lined bars indicate the results of traditional techniques on a trace of 30 seconds. The black bar shows the ground truth of the events. In addition to the true positives, the false negatives, the false positives, events with a higher positional error, events with a lower positional error, and events that were detected but misclassified were plotted as well. As illustrated in FIG. 9L, the machine-learned models with a 10 second acquisition time accurately detected 88.6% of splices. This demonstrated a significant improvement compared to traditional techniques that detected only 73.4% of splices with a 30 second acquisition time and 68.8% of splices with a 10 second acquisition time. Thus, the ensemble of machine-learned models (e.g., the ensemble of machine-learned models 516 described herein) detected and classified significantly more splices than traditional techniques at 10 seconds (about 20% more). Compared to traditional techniques, the major difference was that the ensemble of machine-learned models (e.g., the ensemble of machine-learned models 516 described herein) resulted in improved accuracy in positioning the splices, whereas the traditional techniques resulted in more positional errors.

FIG. 9M shows the detection results of splices in accordance with the SNR. A lower SNR signifies that event is in a noisier area of the trace. The ensemble of machine-learned models (e.g., the ensemble of machine-learned models 516 described herein) had more true positives than the traditional techniques at 10 seconds. FIG. 9M shows that the traditional techniques had difficulty detecting splices at high SNR compared to the ensemble of machine-learned models (e.g., the ensemble of machine-learned models 516 described herein).

FIG. 9N shows positional error of the splices. The top graph shows the distributions of the distance error in meters. The mean and standard deviation were then calculated on the absolute error and plotted in the bottom two graphs, respectively. FIG. 9N shows that the positions of the splices given by the ensemble of machine-learned models (e.g., the ensemble of machine-learned models 516 described herein) were calculated more precisely than traditional techniques.

FIG. 9O shows positional error distribution of splices in relation to SNR. A lower SNR signifies that the splice is in a noisier area of the trace. The values at the top of each SNR section indicate the number of instances/detections for each model. The “GT” corresponds to the ground truth, “input” corresponds to traditional techniques at 10 s, “ML” corresponds to the ensemble of machine-learned models at 10 s, and “gold” corresponds to traditional techniques at 30 s. FIG. 9O shows that the SNR greatly influences the positional error for traditional techniques and the ensemble of machine-learned models (e.g., the ensemble of machine-learned models 516 described herein). The smaller the SNR, the noisier the trace and the greater the positional error.

### IV.Example Processes

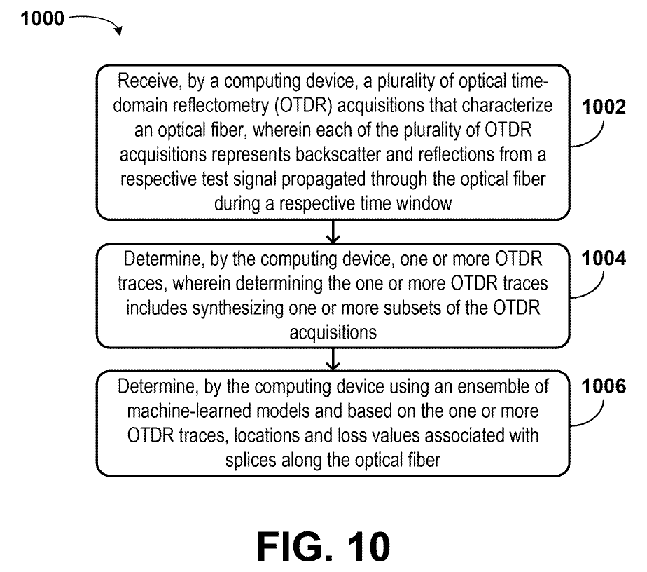

FIG. 10 is a flowchart diagram illustrating a method 1000, according to example embodiments. In some embodiments, the method 1000 may be performed by a system (e.g., the system 300 shown and described with reference to FIG. 3A).

At block 1002, the method 1000 may include receiving, by a computing device, a plurality of OTDR acquisitions that characterize an optical fiber. Each of the plurality of OTDR acquisitions may represent backscatter and reflections from a respective test signal propagated through the optical fiber during a respective time window.

At block 1004, the method 1000 may include determining, by the computing device, one or more OTDR traces. Determining the one or more OTDR traces may include synthesizing one or more subsets of the OTDR acquisitions.

At block 1006, the method 1000 may include determining, by the computing device using an ensemble of machine-learned models and based on the one or more OTDR traces, locations and loss values associated with splices along the optical fiber.

In some embodiments, the method 1000 further includes determining, by the computing device using the ensemble of machine-learned models and based on the one or more OTDR traces, a first portion of a first OTDR trace of the one or more OTDR traces. The first portion of the first OTDR trace corresponds to locations within the optical fiber. The method 1000 may also include determining, by the computing device using the ensemble of machine-learned models and based on the one or more OTDR traces, a second portion of the first OTDR trace that corresponds to locations beyond the optical fiber. Further, the method 1000 may include determining, by the computing device using the ensemble of machine-learned models and based on the first portion of the first OTDR trace and each of the one or more OTDR traces, probabilities of reflective events along the optical fiber. The locations and the loss values associated with the splices along the optical fiber may be determined based on the probabilities of reflective events along the optical fiber, the first portion of the first OTDR trace, and each of the one or more OTDR traces.

Further in example embodiments, the method 1000 may include determining locations, reflectance values, and loss values associated with discrete reflective events along the optical fiber. The locations, the reflectance values, and the loss values associated with the discrete reflective events along the optical fiber may be determined based on the probabilities of reflective events along the optical fiber, the first portion of the first OTDR trace, and each of the one or more OTDR traces.

In some example embodiments, the method 1000 may include determining a location of an end of the optical fiber. The location of the end of the optical fiber may be determined based on the probabilities of reflective events along the optical fiber, the first portion of the first OTDR trace, and each of the one or more OTDR traces.

In some embodiments of the method 1000, synthesizing the one or more subsets of the OTDR acquisitions may include: selecting a subset of the OTDR acquisitions that are captured between a first point in time and a subsequent second point in time; and calculating a mean of the subset of the OTDR acquisitions.

Additionally, in some embodiments of the method 1000, synthesizing the one or more subsets of the OTDR acquisitions may include: selecting an additional subset of the OTDR acquisitions that are captured between a third point in time and a subsequent fourth point in time; and calculating a mean of the additional subset of the OTDR acquisitions. Additionally, the third point in time may coincide with or occur after the second point in time. Further, a difference between the second point in time and the first point in time may be equal to a difference between the fourth point in time and the third point in time.

Further, in some embodiments of the method 1000, the difference between the second point in time and the first point in time may be between 0.5 s and 1.5 s. Additionally, a difference between the fourth point in time and the first point in time may be between 5 s and 15 s.

In some embodiments of the method 1000, synthesizing the one or more subsets of the OTDR acquisitions may include: selecting a subset of the OTDR acquisitions that are captured between a first point in time and a subsequent second point in time; and calculating a standard deviation of, calculating a first derivative of, or detrending the subset of the OTDR acquisitions.

In some embodiments of the method 1000, block 1004 may also include applying a preprocessing technique to at least one of the synthesized subsets of the OTDR acquisitions.

Additionally, in some embodiments of the method 1000, the preprocessing technique may include convolving a Laplacian filter with at least one synthesized subset of the OTDR acquisitions.

Further, in some embodiments of the method 1000, the preprocessing technique may include convolving a step size filter having at least three steps with at least one synthesized subset of the OTDR acquisitions.

In addition, in some embodiments of the method 1000, the preprocessing technique may include convolving a mean filter with at least one synthesized subset of the OTDR acquisitions.

Yet further, in some embodiments of the method 1000, the preprocessing technique may include convolving a left mean filter or a right mean filter with at least one synthesized subset of the OTDR acquisitions.

In some embodiments of the method 1000, at least one of the machine-learned models in the ensemble of machine-learned models may include an artificial neural network. Further, a kernel size of the artificial neural network may correspond to an expected duration of an event being analyzed by the artificial neural network. The event being analyzed may correspond to a splice along the optical fiber.

In some embodiments of the method 1000, at least one of the machine-learned models in the ensemble of machine-learned models may include an artificial neural network. The artificial neural network may include one or more leaky rectified linear unit (leaky ReLU) activation layers.

In some embodiments of the method 1000, determining the locations associated with the splices along the optical fiber may include: determining probabilities of splices along the optical fiber; and comparing the probabilities of splices along the optical fiber to a probability threshold.

In some embodiments of the method 1000, a pulse width of the respective test signal may be between 1 ns and 9 ns (e.g., 5 ns) or between 50 ns and 150 ns (e.g., 100 ns).

Further, in example embodiments, the method 1000 may include determining, based on the locations and loss values associated with splices along the optical fiber, a location of a malfunctioning splice. In such embodiments, the method 1000 may further include performing a remedial action based on the location of the malfunctioning splice. The remedial action may include replacing the optical fiber, repairing the optical fiber, and/or decommissioning the optical fiber.

### V.Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, operation, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step, block, or operation that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer-readable medium such as a storage device including RAM, a disk drive, a solid state drive, or another storage medium.

The computer-readable medium can also include non-transitory computer-readable media such as computer-readable media that store data for short periods of time like register memory and processor cache. The computer-readable media can further include non-transitory computer-readable media that store program code and/or data for longer periods of time. Thus, the computer-readable media may include secondary or persistent long term storage, like ROM, optical or magnetic disks, solid state drives, compact-disc read only memory (CD-ROM), for example. The computer-readable media can also be any other volatile or non-volatile storage systems. A computer-readable medium can be considered a computer-readable storage medium, for example, or a tangible storage device.

Moreover, a step, block, or operation that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed:

1. A method comprising:
receiving, by a computing device, a plurality of optical time-domain reflectometry (OTDR) acquisitions that characterize an optical fiber, wherein each of the plurality of OTDR acquisitions represents backscatter and reflections from a respective test signal propagated through the optical fiber during a respective time window;
determining, by the computing device, one or more OTDR traces, wherein determining the one or more OTDR traces comprises synthesizing one or more subsets of the OTDR acquisitions; and
determining, by the computing device using an ensemble of machine-learned models and based on the one or more OTDR traces, locations and loss values associated with splices along the optical fiber.

2. The method of claim 1, further comprising:
determining by the computing device using the ensemble of machine-learned models and based on the one or more OTDR traces:
a first portion of a first OTDR trace of the one or more OTDR traces, wherein the first portion of the first OTDR trace corresponds to locations within the optical fiber; and
a second portion of the first OTDR trace that corresponds to locations beyond the optical fiber; and
determining, by the computing device using the ensemble of machine-learned models and based on the first portion of the first OTDR trace and each of the one or more OTDR traces, probabilities of reflective events along the optical fiber,
wherein the locations and the loss values associated with the splices along the optical fiber are determined based on the probabilities of reflective events along the optical fiber, the first portion of the first OTDR trace, and each of the one or more OTDR traces.

3. The method of claim 2, further comprising determining locations, reflectance values, and loss values associated with discrete reflective events along the optical fiber, wherein the locations, the reflectance values, and the loss values associated with the discrete reflective events along the optical fiber are determined based on the probabilities of reflective events along the optical fiber, the first portion of the first OTDR trace, and each of the one or more OTDR traces.

4. The method of claim 2, further comprising determining a location of an end of the optical fiber, wherein the location of the end of the optical fiber is determined based on the probabilities of reflective events along the optical fiber, the first portion of the first OTDR trace, and each of the one or more OTDR traces.

5. The method of claim 1, wherein synthesizing the one or more subsets of the OTDR acquisitions comprises:
selecting a subset of the OTDR acquisitions that are captured between a first point in time and a subsequent second point in time; and
calculating a mean of the subset of the OTDR acquisitions.

6. The method of claim 5,
wherein synthesizing the one or more subsets of the OTDR acquisitions comprises:
selecting an additional subset of the OTDR acquisitions that are captured between a third point in time and a subsequent fourth point in time; and
calculating a mean of the additional subset of the OTDR acquisitions,
wherein the third point of time coincides with or occurs after the second point in time, and
wherein a difference between the second point in time and the first point in time is equal to a difference between the fourth point in time and the third point in time.

7. The method of claim 6,
wherein the difference between the second point in time and the first point in time is between 0.5 s and 1.5 s, and
wherein a difference between the fourth point in time and the first point in time is between 5 s and 15 s.

8. The method of claim 1, wherein synthesizing the one or more subsets of the OTDR acquisitions comprises:
selecting a subset of the OTDR acquisitions that are captured between a first point in time and a subsequent second point in time; and
calculating a standard deviation of, calculating a first derivative of, or detrending the subset of the OTDR acquisitions.

9. The method of claim 1, wherein determining the one or more OTDR traces further comprises applying a preprocessing technique to at least one of the synthesized subsets of the OTDR acquisitions.

10. The method of claim 9, wherein the preprocessing technique comprises convolving a Laplacian filter with the at least one synthesized subset of the OTDR acquisitions.

11. The method of claim 9, wherein the preprocessing technique comprises convolving a step size filter having at least three steps with the at least one synthesized subset of the OTDR acquisitions.

12. The method of claim 9, wherein the preprocessing technique comprises convolving a mean filter with the at least one synthesized subset of the OTDR acquisitions.

13. The method of claim 9, wherein the preprocessing technique comprises convolving a left mean filter or a right mean filter with the at least one synthesized subset of the OTDR acquisitions.

14. The method of claim 1, wherein at least one of the machine-learned models in the ensemble of machine-learned models comprises an artificial neural network, wherein a kernel size of the artificial neural network corresponds to an expected duration of an event being analyzed by the artificial neural network, and wherein the event being analyzed by the artificial neural network corresponds to a splice along the optical fiber.

15. The method of claim 1, wherein at least one of the machine-learned models in the ensemble of machine-learned models comprises an artificial neural network, and wherein the artificial neural network comprises one or more leaky rectified linear unit (leaky ReLU) activation layers.

16. The method of claim 1, wherein determining the locations associated with the splices along the optical fiber comprises:
determining probabilities of splices along the optical fiber; and
comparing the probabilities of splices along the optical fiber to a probability threshold.

17. The method of claim 1, wherein a pulse width of the respective test signal is between 1 ns and 9 ns or between 50 ns and 150 ns.

18. The method of claim 1, further comprising:
determining, based on the locations and loss values associated with splices along the optical fiber, a location of a malfunctioning splice; and
performing a remedial action based on the location of the malfunctioning splice, wherein the remedial action comprises replacing the optical fiber, repairing the optical fiber, or decommissioning the optical fiber.

19. A non-transitory computer-readable medium, having stored thereon program instructions that, upon execution by a computing device, cause the computing device to perform operations, the operations comprising:
receiving a plurality of optical time-domain reflectometry (OTDR) acquisitions that characterize an optical fiber, wherein each of the plurality of OTDR acquisitions represents backscatter and reflections from a respective test signal propagated through the optical fiber during a respective time window;
determining one or more OTDR traces, wherein determining the one or more OTDR traces comprises synthesizing one or more subsets of the OTDR acquisitions; and
determining, using an ensemble of machine-learned models and based on the one or more OTDR traces, locations and loss values associated with splices along the optical fiber.

20. A system comprising:
an optical time-domain reflectometry OTDR acquisition device configured to perform OTDR measurements on an optical fiber to obtain a plurality of OTDR acquisitions that characterize the optical fiber, wherein each of the plurality of OTDR acquisitions represents backscatter and reflections from a respective test signal propagated through the optical fiber during a respective time window; and
a computing device configured to:
receive the plurality of OTDR acquisitions from the OTDR acquisition device;
determine one or more OTDR traces, wherein determining the one or more OTDR traces comprises synthesizing one or more subsets of the OTDR acquisitions; and
determine, using an ensemble of machine-learned models and based on the one or more OTDR traces, locations and loss values associated with splices along the optical fiber.
